(19) United States
(12) Patent Application Publication
(10) Pub. No.: US 2008/0084503 A1
(43) Pub. Date: Apr. 10, 2008

(54) APPARATUS, METHOD, AND COMPUTER PROGRAM FOR PROCESSING IMAGE

(75) Inventor: Tetsujiro Kondo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/856,285

(22) Filed: Sep. 17, 2007

(30) Foreign Application Priority Data
Oct. 10, 2006 (JP) 2006-276045

(51) Int. Cl. H04N 5/46

(52) U.S. Cl. 348/556

(57) ABSTRACT

An image processing apparatus for causing a display unit to display an image, includes an image format detecting unit for detecting an image format of the image containing an aspect ratio of the image, a converting unit for converting an effective image as an effective moving image portion of the image into a display image in accordance with the image format and a screen format of a display screen of the display unit, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image, and a scroll processing unit for scrolling the display image displayed on the display unit in a direction that causes a non-display area as a portion of the display image not appearing on the display screen to appear.

### CROSS REFERENCES TO RELATED APPLICATIONS

The present invention contains subject matter related to Japanese Patent Application JP 2006-276045 filed in the Japanese Patent Office on Oct. 10, 2006, the entire contents of which are incorporated herein by reference.

### BACKGROUND OF THE INVENTION

1. Field of the Invention

The present invention relates to an apparatus, a method and a computer program for processing an image. In particular, the present invention relates to an apparatus, a method and a computer program for displaying an image with an entire display screen of a television receiver or the like efficiently used without deforming an image of a subject.

2. Description of the Related Art

A variety of aspect ratios of images are currently used.

FIG. 1 illustrates a variety of aspect ratios of images.

With the vertical length of an image being unity, ratios of the currently available horizontal lengths of the image are 1.33, 1.37, 1.66, 1.78, 1.85 and 2.35.

An image having a horizontal length ratio of 1.33 with respect to unity is an analog terrestrial broadcast image having a 4:3 aspect ratio (horizontal-to-vertical ratio).

An image having a horizontal length ratio of 1.37 with respect to unity is called standard format image.

Images having horizontal length ratios of 1.66 and 1.85 with respect to unity are generally called vista. The image having the horizontal length ratio of 1.66 is called European vista and the image having the horizontal length ratio of 1.85 is called American vista.

An image having a horizontal length ratio of 1.78 with respect to unity is a digital terrestrial broadcast image having a 16:9 aspect ratio.

An image having a horizontal length ratio of 2.35 with respect to unity is called a cinemascope image.

Media supplying image includes transmission media such as analog terrestrial broadcasting, digital terrestrial broadcasting, and satellite broadcasting, and recording media such as digital versatile disk (DVD) and movie films.

Images different in aspect ratio such as an aspect ratio of an entire image and an aspect ratio of an effective moving portion of the image (hereinafter referred to as effective image) are supplied in the media.

FIGS. 2A-2C illustrate images different in image format. FIG. 2A illustrates an image having an image format in which the entire image having an aspect ratio of 4:3 becomes an effective image (hereinafter referred to as standard 4:3 image).

Since the entire area of the standard 4:3 image is typically an effective image, the aspect ratio of the effective image is also identical to the aspect ratio of the entire image, namely, 4:3.

The entire image having an aspect ratio 4:3 may also be referred to as a 4:3 image.

FIG. 2B illustrates an image having an image format in which the entire image having an aspect ratio of 16:9 becomes an effective image (hereinafter referred to as standard 16:9 image).

Since the entire area of the standard 16:9 image is typically an effective image, the aspect ratio of the effective image is also identical to the aspect ratio of the entire image, namely, 16:9.

The entire image having an aspect ratio 16:9 may also be referred to as a 16:9 image.

FIG. 2C illustrates a so-called letterbox image. The entire area of the letterbox image having an aspect ratio of 4:3 includes an effective image having an aspect ratio of 16:9 and black bands above and below the effective area.

The letterbox image has an aspect ratio 4:3 as the image shown in FIG. 2A. The letterbox image contains an effective image having an aspect ratio of 16:9 and an entire image thereof having an aspect ratio of 4:3 and is different from the standard 4:3 image with the entire image having an aspect ratio of 4:3.

In the letterbox image, the black bands (a portion not being an effective image) attached above and below the effective image having an aspect ratio of 16:9 are referred to as letterbox areas.

FIGS. 3A and 3B illustrate a display screen of a display such as a TV receiver displaying the images having the image formats of FIGS. 2A-2C.

More specifically, FIG. 3A illustrates a display screen having an aspect ratio (horizontal to vertical ratio) of 4:3 and FIG. 3B illustrates a display screen having an aspect ratio of 16:9.

The display screen having an aspect ratio of 4:3 and the display screen having an aspect ratio of 16:9 are respectively referred to as a 4:3 screen and a 16:9 screen.

The image having the aspect ratio of the effective image thereof equal to the aspect ratio of the entire image thereof might be displayed on a display screen having the same aspect ratio as the entire image. For example, the standard 4:3 image might be displayed on the 4:3 screen, or the standard 16:9 image might be displayed on the 16:9 screen. In such a case, the effective image is displayed on the entire display screen. The entire display screen is thus effectively used to display the image without deforming an image of a subject.

However, there are cases where the entire display screen is not effectively used.

FIGS. 4A-4D illustrate such cases where the entire display screen is not effectively used in the displaying of the image.

FIG. 4A illustrates a display example in which the standard 16:9 image is displayed on the 4:3 screen.

The standard 16:9 image, when displayed on the 4:3 screen, is associated with the black bands appearing thereabove and therebelow on the 4:3 screen in the letterbox format because of the difference between the aspect ratio of the entire image of the standard 16:9 image and the aspect ratio of the 4:3 screen.

With the standard 16:9 image displayed on the 4:3 screen, the black bands of the top and bottom portions of the 4:3 screen are unused areas.

FIG. 4B illustrates a display example in which the standard 4:3 image is displayed on the 16:9 screen.

The standard 4:3 image, when displayed on the 16:9 screen, is associated with the black bands appearing on both sides thereof on the 16:9 screen in a side panel format because of the difference between the aspect ratio of the entire image of the standard 4:3 image and the aspect ratio of the 16:9 screen.

With the standard 4:3 image displayed on the 16:9 screen, the black bands of the side portions of the 16:9 screen are unused areas.

FIG. 4C illustrates a display example in which a letterbox image is displayed on the 4:3 screen.

The aspect ratio of the entire image of the letterbox image equals the aspect ratio of the 4:3 screen. The letterbox, when displayed on the 4:3 screen, appears in the same manner as the standard 4:3 image is displayed on the 4:3 screen (as shown in FIG. 4A).

The letterbox image includes the letterbox areas above and below the effective image of an aspect ratio of 16:9. In the 4:3 screen, the letterbox area is an unused portion after all.

FIG. 4D illustrates a display example in which the letterbox image is displayed on the 16:9 screen.

The letterbox image, when displayed on the 16:9 screen, appears in the same manner as the standard 4:3 image is displayed on the 16:9 screen (as shown in FIG. 4B). Black bands are displayed on both sides of the letterbox image in the side panel fashion. The black bands on the 16:9 screen remain unused.

The letterbox image contains the letterbox areas above and below the effective image of an aspect ratio of 16:9. The letterbox areas in the 16:9 screen are also unused.

When the image having the aspect ratio of the effective area is displayed on the display screen having an aspect ratio different from the effective area of the image or when the image having the aspect ratio of the effective image thereof different from the aspect ratio of the entire image thereof is displayed, the unused area is caused on the effective image on the display screen. The entire display screen is not effectively used in the displaying of the image.

Japanese Patent No. 2759727 discloses one technique that converts an aspect ratio of the standard 4:3 image to expand a horizontal one of vertical and horizontal lengths of the standard 4:3 image when the standard 4:3 image is displayed on the 16:9 screen. An image with an effective area having an aspect ratio 16:9 is then obtained and displayed on the entire area of the 16:9 screen.

### SUMMARY OF THE INVENTION

The unused area in the effective screen on the display area of a TV receiver or the like is not preferable because the original definition of the TV receiver is not fully used.

In accordance with Japanese Patent No. 2759727, the aspect ratio of the standard 4:3 image is converted to obtain an effective image having an aspect ratio of 16:9, and the image is thus displayed on the entire display screen. In the effective image having an aspect ratio of 16:9, a subject photographed in the original standard 4:3 image is changed in aspect ratio. For example, the face of a person may appear wider.

It is not preferable that the subject photographed in the image is displayed in an aspect ratio different from the original aspect ratio, because original information of the subject is lost.

It is thus desirable to display a subject on a display screen in a manner that the entire display screen is effectively used without deforming the image of the subject.

In accordance with one embodiment of the present invention, an image processing apparatus for causing a display unit to display an image include an image format detecting unit for detecting an image format of the image containing an aspect ratio of the image, a converting unit for converting an effective image as an effective moving image portion of the image into a display image in accordance with the image format and a screen format of a display screen of the display unit, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image, and a scroll processing unit for scrolling the display image displayed on the display unit in a direction that causes a non-display area as a portion of the display image not appearing on the display screen to appear.

In accordance with one embodiment of the present invention, one of an image processing method and a computer program for causing a display to display an image, includes steps of detecting an image format of the image containing an aspect ratio of the image, converting an effective image as an effective moving image portion of the image into a display image in accordance with the image format and a screen format of a display screen of the display, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image, and scrolling the display image displayed on the display in a direction that causes a non-display area as a portion of the display image not appearing on the display screen to appear.

In accordance with embodiments of the present invention, the image format of the image containing the aspect ratio of the image is detected. The effective image as the effective moving image portion of the image is converted into the display image in accordance with the image format and the screen format of the display screen of the display. The display image has one of the horizontal size and the vertical size thereof equal to one of the horizontal size and the vertical size of the display screen, and has an image size thereof, being equal to or greater than the size of the display screen and resulting from magnifying the effective image with the same magnification applied to the horizontal size and the vertical size of the effective image. The display image displayed on the display is scrolled in a direction that causes a non-display area as a portion of the display image not appearing on the display screen to appear.

The computer program is may be supplied via a transmission medium or via a recording medium.

In accordance with embodiments of the present invention, the image is displayed on the display screen in a manner such that the entire display screen is effectively used without deforming the subject in the image.

### BRIEF DESCRIPTION OF THE DRAWINGS

FIG. 1 illustrates images of a variety of aspect ratios;

FIGS. 2A-2C illustrate a variety of image formats;

FIGS. 3A and 3B illustrate display screens of displays;

FIGS. 4A-4D illustrate display examples in which an entire display screen is not effectively used to display an image;

FIG. 5 is a block diagram illustrating a display system in accordance with one embodiment of the present invention;

FIGS. 6A-6C illustrate a process of a reading unit;

FIGS. 7A and 7B illustrate a process of an image converter;

FIGS. 8A and 8B illustrate a process of the image converter;

FIG. 9 illustrates a process of a display controller;

FIG. 10 is a block diagram illustrating the display controller;

FIG. 11 is a flowchart illustrating a process of a display processing apparatus;

FIG. 12 is a flowchart illustrating a scroll process;

FIG. 13 is a block diagram illustrating a display system in accordance with one embodiment of the present invention;

FIG. 14 illustrates a display image displayed on a display screen of a display;

FIG. 15 illustrates a ticker process performed by a display controller;

FIG. 16 illustrates the ticker process performed by the display controller;

FIGS. 17A and 17B illustrate a display image where a ticker area is present in both a non-display area and a blend area;

FIG. 18 illustrates an automatic scroll process;

FIG. 19 is a block diagram illustrating the display controller;

FIG. 20 is a flowchart illustrating a ticker process;

FIG. 21 is a block diagram illustrating an image conversion apparatus for converting an image in accordance with class classification adaptive process;

FIG. 22 is a flowchart illustrating an image conversion process performed by the image conversion apparatus;

FIG. 23 is a block diagram illustrating a learning apparatus learning a tap coefficient;

FIG. 24 is a block diagram illustrating the learning unit in a learning apparatus;

FIGS. 25A-25D illustrate image conversion processes;

FIG. 26 is a flowchart illustrating a learning process of the learning apparatus;

FIG. 27 is a block diagram illustrating an image converting apparatus converting an image in accordance with class classification adaptive process;

FIG. 28 is a block diagram illustrating a coefficient output unit in the image converting apparatus;

FIG. 29 is a block diagram illustrating a learning apparatus learning coefficient seed data;

FIG. 30 is a block diagram illustrating a learning unit in the learning apparatus;

FIG. 31 is a flowchart illustrating a learning process of the learning apparatus; and

FIG. 32 is a block diagram illustrating a computer in accordance with one embodiment of the present invention.

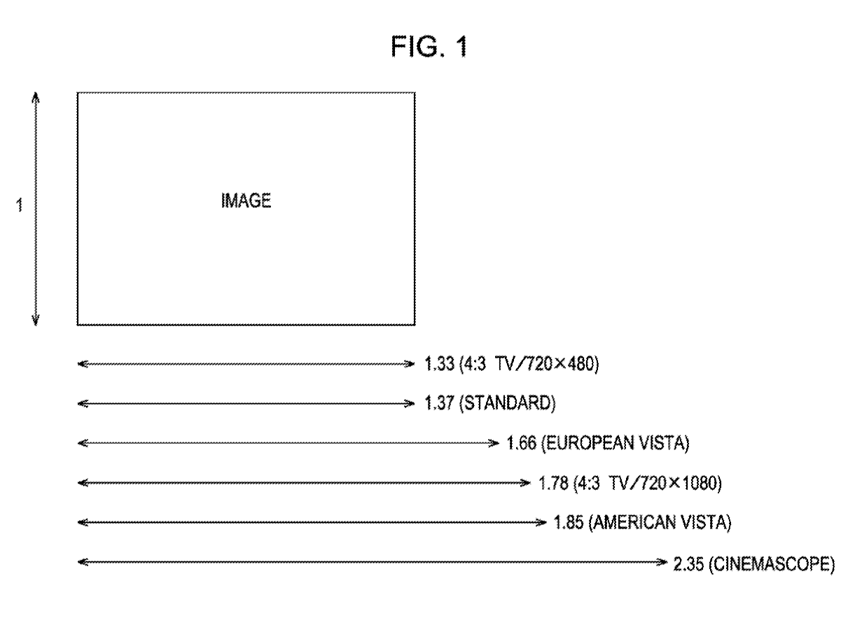

### DESCRIPTION OF THE PREFERRED EMBODIMENTS

Before describing an embodiment of the present invention, the correspondence between the features of the present invention and an embodiment disclosed in the specification or the drawings of the invention is discussed below. This statement is intended to assure that embodiments supporting the claimed invention are described in this specification or the drawings. Thus, even if an embodiment is described in the specification or the drawings, but not described as relating to a feature of the invention herein, that does not necessarily mean that the embodiment does not relate to that feature of the invention. Conversely, even if an embodiment is described herein as relating to a certain feature of the invention, that does not necessarily mean that the embodiment does not relate to other features of the invention.

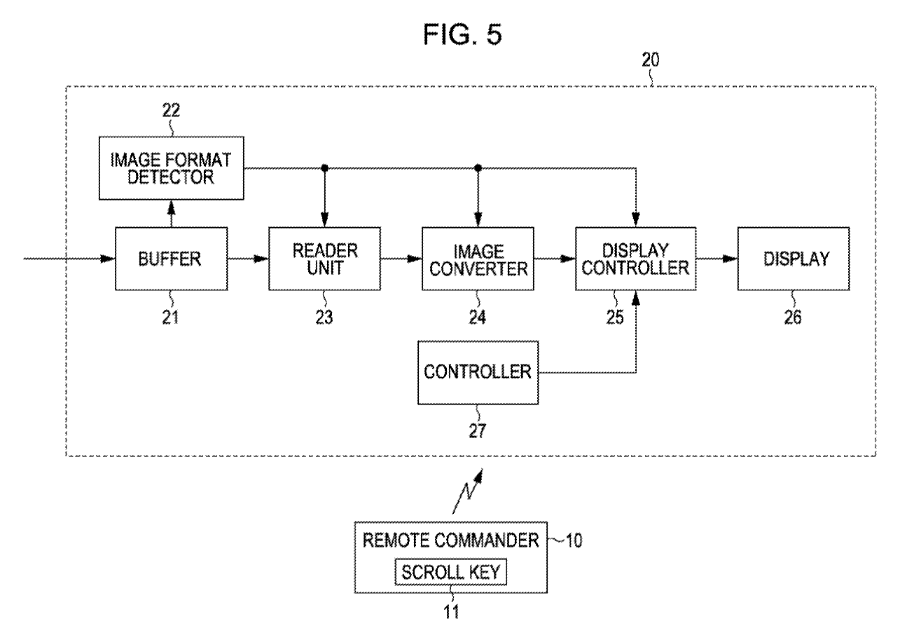

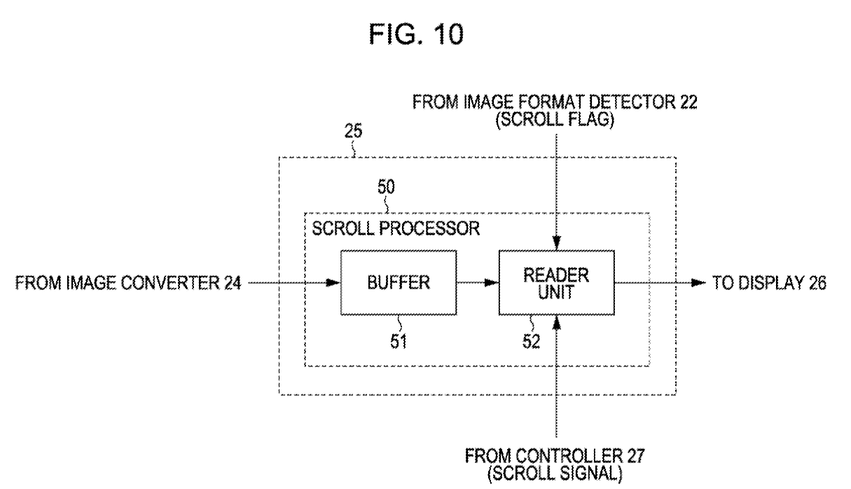

In accordance with one embodiment of the present invention, an image processing apparatus (for example, display system of FIG. 5) for causing a display unit (for example, display 26 of FIG. 5) to display an image, includes an image format detecting unit (for example, image format detector 22 of FIG. 5) for detecting an image format of the image containing an aspect ratio of the image, a converting unit (for example, image converter 24 of FIG. 5) for converting an effective image as an effective moving image portion of the image into a display image in accordance with the image format and a screen format of a display screen of the display unit, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image, and a scroll processing unit (for example, scroll processor 50 of FIG. 10 in display controller 25 of FIG. 5) for scrolling the display image displayed on the display unit in a direction that causes a non-display area as a portion of the display image not appearing on the display screen to appear.

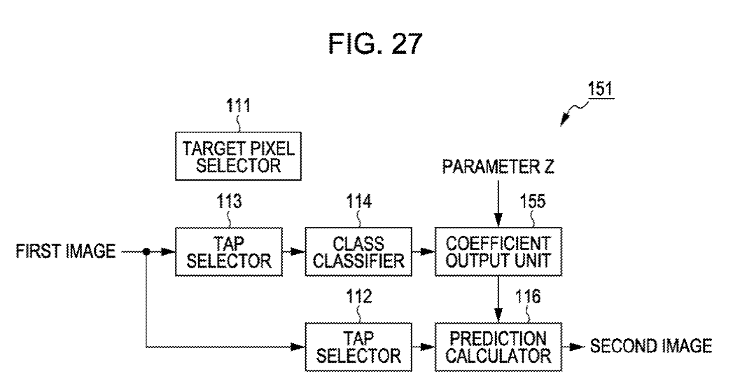

The converting unit may include a predictive tap selecting unit (for example, tap selector 112 of FIG. 27) for selecting from the effective image a pixel serving as a predictive tap for use in prediction calculation to determine a pixel value of a target pixel in the display image, a class classifying unit (for example, class classifier 114 of FIG. 27) for classifying the target pixel into one of a plurality of classes according to a predetermined rule, a tap coefficient output unit (for example, coefficient output unit 155 of FIG. 27) for outputting a tap coefficient of the class of the target pixel from among tap coefficients, the tap coefficients being determined in a learning operation that minimizes an error between the result of the prediction calculation based on the effective image as a student image and the display image as a supervisor image, and being used in the prediction calculation in each of the plurality of classes, and a calculating unit (for example, prediction calculator 116 of FIG. 27) for calculating the pixel value of the target pixel by performing the prediction calculation using the tap coefficient of the class of the target pixel and the predictive tap of the target pixel.

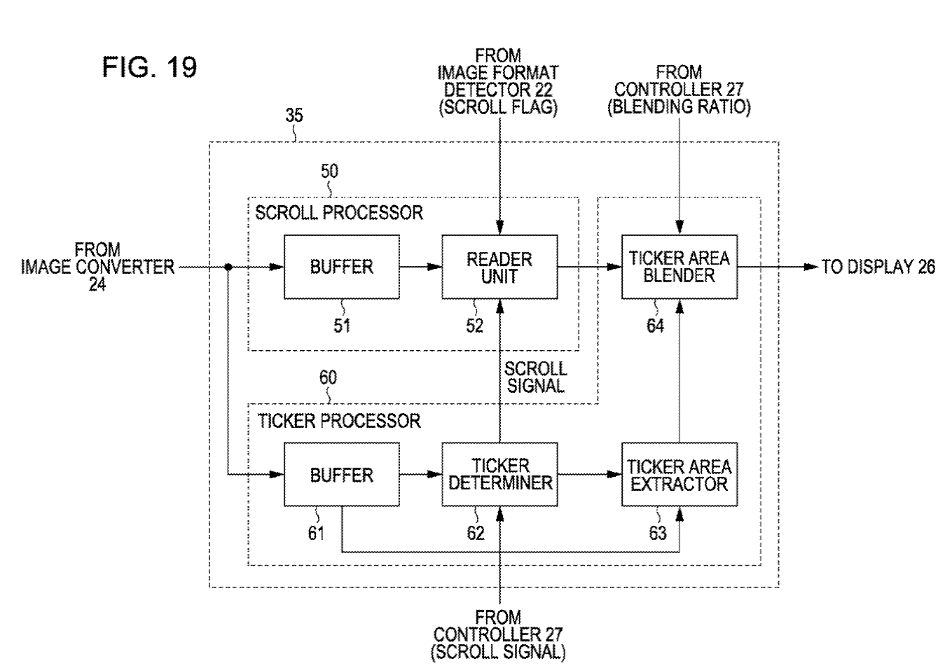

The image processing apparatus may further include a ticker determining unit (for example, ticker determiner 62 of FIG. 19) for determining whether a ticker area containing a ticker is present in the non-display area of the display image, and a ticker area blending unit (for example, ticker area blender 64 of FIG. 19) for blending the ticker area of the non-display area with a blend area as part of the display area of the display image displayed on the display screen according to a predetermined blending ratio.

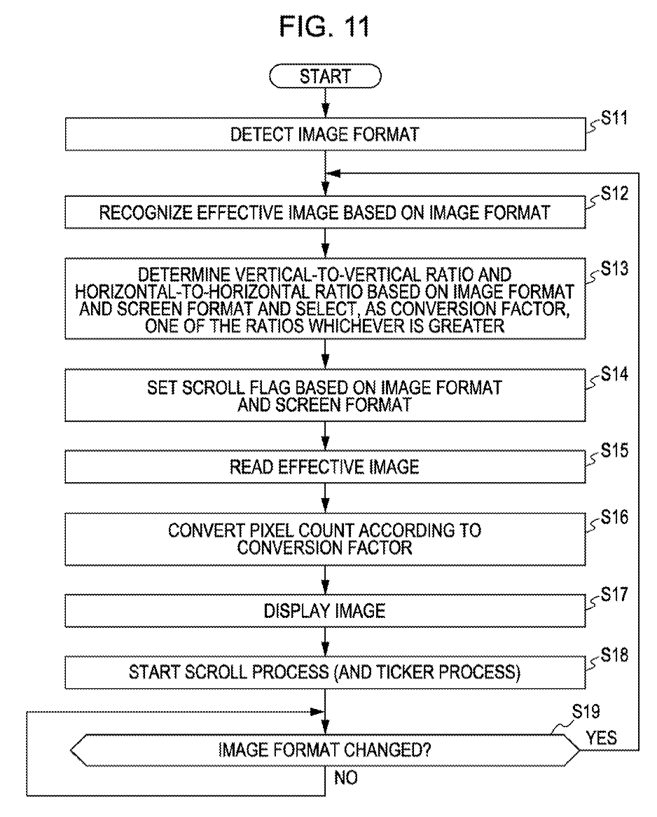

In accordance with one embodiment of the present invention, one of an image processing method and a computer program for causing a display to display an image, includes steps of detecting an image format of the image containing an aspect ratio of the image (for example, in step S11 of FIG. 11), converting an effective image as an effective moving image portion of the image into a display image in accordance with the image format and a screen format of a display screen of the display, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image (for example, in step S16 of FIG. 11), and scrolling the display image displayed on the display in a direction that causes a non-display area as a portion of the display image not appearing on the display screen to appear (for example, in step S18 of FIG. 11).

The embodiments of the present invention are described below with reference to the drawings.

For simplicity of explanation of this specification, each pixel has the horizontal and vertical lengths equal to each other.

FIG. 5 illustrates a display system in accordance with one embodiment of the present invention. The system herein refers to a logical set of a plurality of apparatuses and it is not important whether or not the apparatuses are housed in the same casing.

The display system of FIG. 5 includes a remote commander 10 and a display processing apparatus 20.

The remote commander 10 includes a scroll key 11 for scrolling an image displayed on the display processing apparatus 20, a power key (not shown) for switching on and off the display processing apparatus 20, and other keys. The remote commander 10, operated by a user, transmits an operation signal generated by a user operation to the display processing apparatus 20 using electromagnetic wave including infrared light.

The display processing apparatus 20 is a TV receiver as an image processing apparatus and includes a buffer 21, an image format detector 22, a reader unit 23, an image converter 24, a display controller 25, a display 26 and a controller 27.

The buffer 21 receives data containing image broadcast via a digital terrestrial broadcasting system, for example. The buffer 21 temporarily stores the data.

The image format detector 22 detects an aspect ratio of an entire image contained in the data stored on the buffer 21, and an image format containing an aspect ratio of an effective image as an effective moving image portion in the image. The image format detector 22 controls the reader unit 23, the image converter 24 and the display controller 25 in accordance with the image format and further the screen format of the display screen of the display 26.

The image format detector 22 pre-stores the screen format of the display screen of the display 26. The screen format include an aspect ratio of the display screen of the display 26 and a screen size of the display screen of the display 26 represented by the number of pixels (pixel count) in a horizontal direction and a vertical direction. The display 26 may be arranged to be external to the display processing apparatus 20. In such a case, the external display 26 supplies the screen format thereof to the image format detector 22.

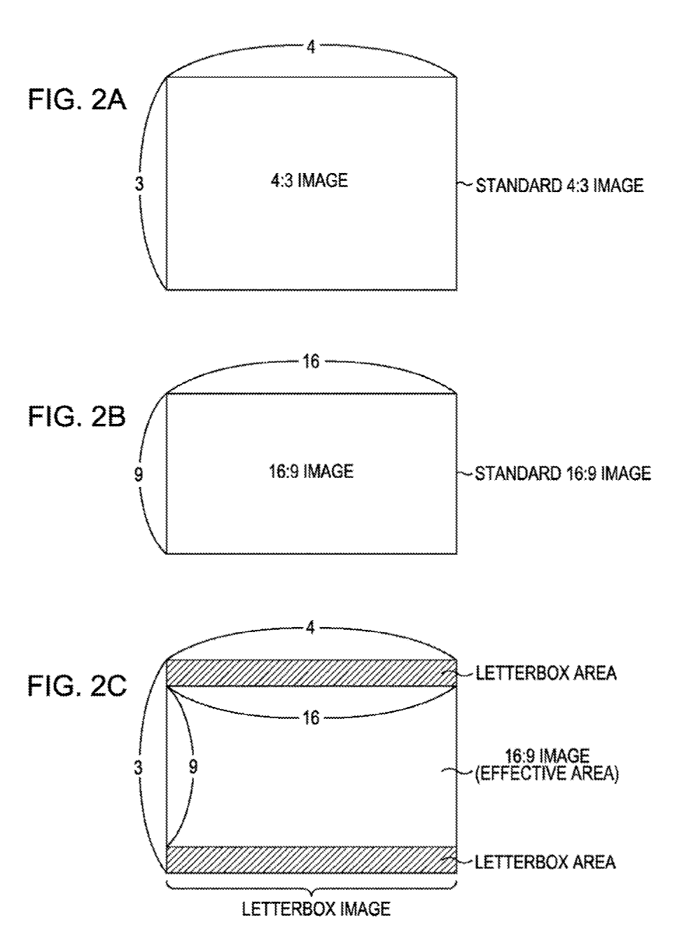

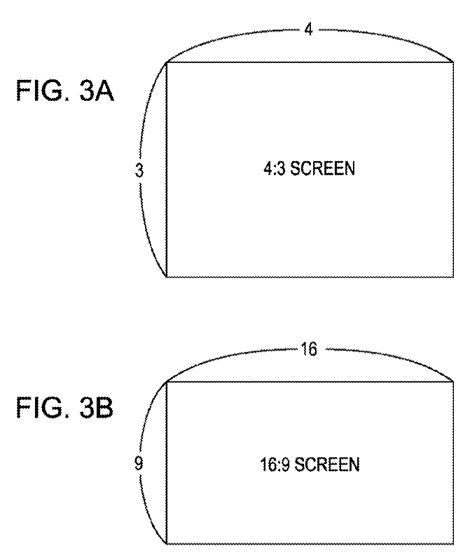

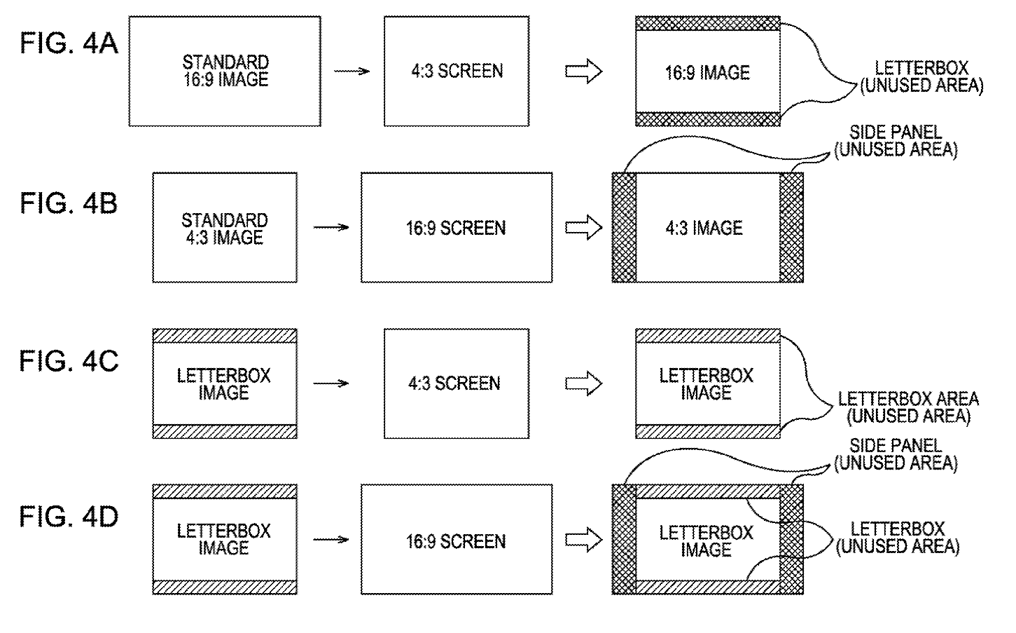

The image contained in the data stored on the buffer 21 may have any screen format. For simplicity of explanation, the image is one of the three types described above, namely, the standard 4:3 image, the standard 16:9 image and the letterbox image as shown in FIG. 2.

Furthermore, the screen format detected by the image format detector 22 contains the aspect ratio and information providing the image size of the effective image represented in the horizontal pixel count and the vertical pixel count.

When the information regarding the image format is contained in the broadcast data, the image format detector 22 detects the image format from the broadcast data.

The image format detector 22 may detect the image format relating to an image of content, only once or repeatedly. If the image format of the image of the content is detected only once, the image format detection may be performed each time contents are changed.

The reader unit 23 under the control of the image format detector 22 reads the effective image from the image contained in the data stored on the buffer 21 and supplies to the image converter 24 the effective image as a target image to be size converted as will be described later.

The image converter 24 under the control of the image format detector 22 converts into a display image the effective image as the target image from the reader unit 23 in accordance with the image format and the screen format. The display image has one of the horizontal size and the vertical size thereof equal to one of the horizontal size and the vertical size of the display screen of the display 26, and has an image size thereof being equal to or greater than the screen size of the display screen of the display 26, the image size being obtained by magnifying the effective image with the same magnification applied to the vertical size and the horizontal size of the effective image. The display image is thus supplied to the display controller 25.

The display controller 25 causes the display 26 to display the display image from the image converter 24. The display controller 25 under the control of the image format detector 22 and the controller 27 scrolls the display image on the display 26 in a direction that causes a non-display area as a portion of the display image undisplayed on the display screen of the display 26 to appear.

The display 26 includes a cathode ray tube (CRT), a liquid-crystal display (LCD), or the like and displays a display image on the display screen thereof under the control of the display controller 25.

The controller 27 receives an operation signal transmitted from the remote commander 10 and controls the display controller 25 in response to the operation signal.

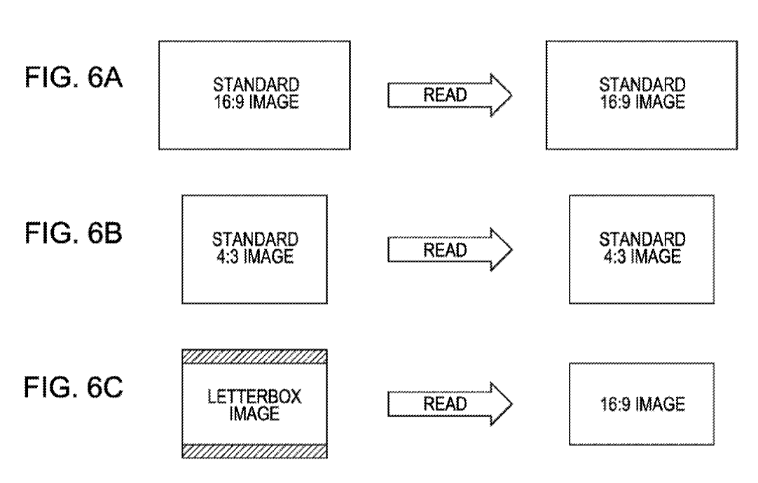

The process of the reader unit 23 of FIG. 5 is further described below with reference to FIGS. 6A-6C.

As described above, the reader unit 23 under the control of the image format detector 22 reads an effective image from the images contained in the data stored on the buffer 21 as a target image to be size converted and then supplies the effective image to the image converter 24.

In accordance with the present embodiment, the buffer 21 (FIG. 5) stores the data containing one of the standard 4:3 image, the standard 16:9 image and the letterbox image.

The image format detector 22 detects the image format containing the aspect ratio of the entire portion of an image contained in the data stored on the buffer 21, the aspect ratio of the effective image of that image, and the image size of that image. The image format detector 22 then controls the reader unit 23 in accordance with the detected image format.

In accordance with the image format, the image format detector 22 controls the reader unit 23, thereby recognizing and reading the effective image of the image contained in the data stored on the buffer 21.

If the image contained in the data stored on the buffer 21 is one of the standard 16:9 image and the standard 4:3 image with the effective image thereof expanded all over the image, the reader unit 23 reads the whole standard 16:9 image or the whole standard 4:3 image as the target image as shown in FIGS. 6A and 6B, and supplies the read image to the image converter 24.

If the image contained in the data stored on the buffer 21 is a letterbox image with part thereof being an effective image, the reader unit 23 reads as a target image a 16:9 image as an effective image having an aspect ratio of 16:9 without the upper and lower letterbox areas and then supplies the 16:9 image to the image converter 24.

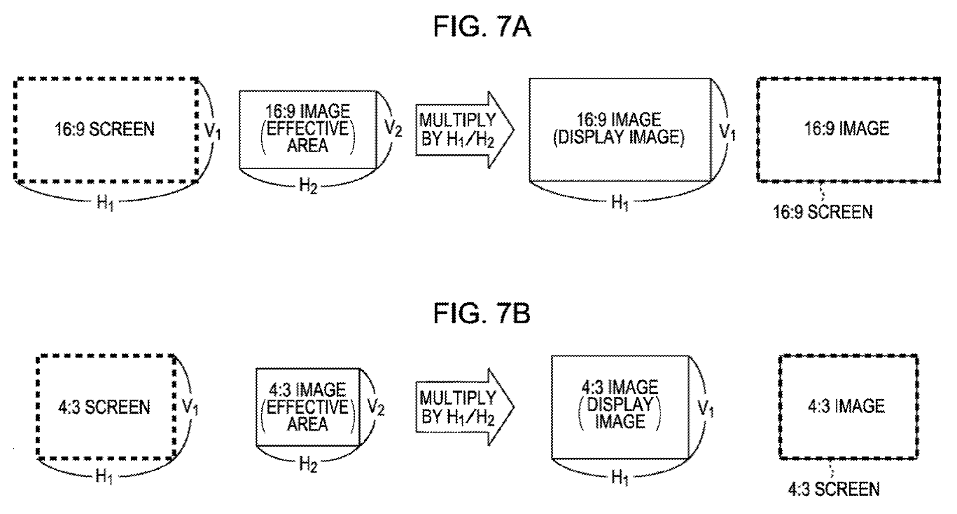

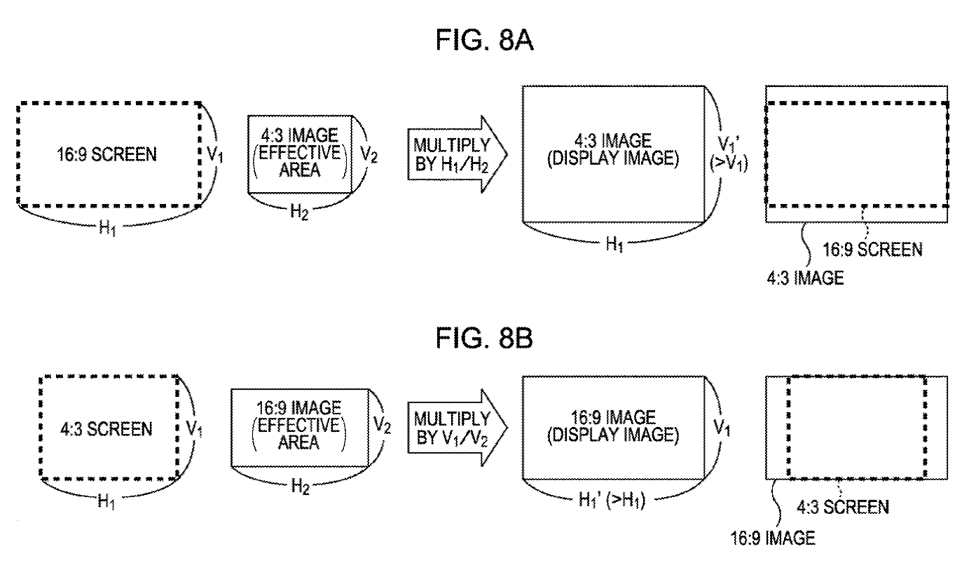

The process of the image converter 24 of FIG. 5 is described below with reference to FIGS. 7A and 7B and FIGS. 8A and 8B.

The image converter 24 under the control of the image format detector 22 performs size conversion. More specifically, the image converter 24 converts into the display image the effective image as the target image from the reader unit 23 in accordance with the image format and the screen format. The display image has one of the horizontal size and the vertical size thereof equal to one of the horizontal size and the vertical size of the display screen of the display 26, and has the image size thereof being equal to or greater than the screen size of the display screen of the display 26, and being obtained by magnifying the effective image with the same magnification applied to the vertical size and the horizontal size of the effective image.

In accordance with the image format and the screen format, the image format detector 22 determines whether the aspect ratio of the effective image as the target image equals the aspect ratio of the display screen of the display 26.

If the aspect ratio of the effective image as the target image equals the aspect ratio of the display screen, the image format detector 22 controls the image converter 24 to convert the effective image into the display image as shown in FIGS. 7A and 7B. If the aspect ratio of the effective image as the target image does not equal the aspect ratio of the display screen, the image format detector 22 controls the image converter 24 to convert the effective image into the display image as shown in FIGS. 8A and 8B.

More specifically, if the aspect ratio of the effective image as the target image equals the aspect ratio of the display screen, the image format detector 22 determines a conversion factor H₁/H₂ as shown in FIG. 7A. Let H1 represent the vertical pixel count as one of the horizontal size and the vertical size of the display screen and H2 represent the pixel count of the effective image as one of the horizontal size and the vertical size of the effective image, and the conversion factor H₁/H₂ is a magnification that makes the horizontal pixel count of the effective image equal to the vertical pixel count of the display screen. The image format detector 22 controls the image converter 24 to multiple each of the horizontal pixel count and the vertical pixel count of the effective image by the conversion factor H₁/H₂.

The image converter 24 under the control of the image format detector 22 multiplies each of the horizontal pixel count and the vertical pixel count of the effective image as the target image from the reader unit 23 by the conversion factor H₁/H₂. In this way, the effective image is converted into the display image. In the display image, one of the horizontal pixel count and the vertical pixel count of the effective image equals one of the horizontal pixel count and the vertical pixel count of the display screen. The display image has the size that is obtained by multiplying each of the horizontal pixel count and the vertical pixel count of the effective image by the conversion factor H₁/H₂.

Since the aspect ratio of the effective image as the target image equals the aspect ratio of the display screen, a ratio V₁/V₂ of the number of pixels V₁ of the display screen in the vertical direction to the number of pixels V₂ of the effective image in the vertical direction equals the conversion factor H₁/H₂ (ratio V₁/V₂ of the number of pixels V₁ of the display screen in the vertical direction to the number of pixels V₂ of the effective image in the vertical direction may also be referred to as a conversion factor).

By multiplying each of the horizontal pixel count and the vertical pixel count of the effective image (H₂×V₂) by the conversion factor H₁/H₂ (=V₁/V₂), the display image having the horizontal pixel count and the vertical pixel count (H₁×V₁) results. The display image has one of the horizontal size and the vertical size thereof equal to one of the horizontal size and the vertical size of the display screen, and has the image size equal to the screen size of the display screen, and being obtained by multiplying each of the horizontal pixel count and the vertical pixel count of the effective image by the same conversion factor H₁/H₂.

FIG. 7A illustrates the display image in which the aspect ratio of the effective image equals the aspect ratio of the display screen, namely, 16:9.

FIG. 7B illustrates the display image in which each of the aspect ratio of the effective image and the aspect ratio of the display screen is 4:3.

When the aspect ratio of the effective image is equal to the aspect ratio of the display screen, the image converter 24 converts the effective image in size. The image of the display image, for example, the horizontal pixel count and the vertical pixel count match the screen size of the display screen. The display image is thus displayed on the display 26 with the entire display screen effectively used.

Since the display image is obtained by magnifying the horizontal size and the vertical size of the effective image by the conversion factor H₁/H₂, the aspect ratio of the display image equals the aspect ratio of the effective image. More specifically, the display image becomes a 4:3 image if the effective image is a 4:3 image, and the display image becomes a 16:9 image if the effective image is a 16:9 image. As a result, any subject in the effective image is shown in a manner free from distortion.

If the aspect ratio of the effective image as the target image is not equal to the aspect ratio of the display screen, the image format detector 22 determines a conversion factor K. The conversion factor K is a magnification that causes one of the horizontal pixel count and the vertical pixel count of the effective image to equal the pixel count of the display screen in the corresponding direction based on the aspect ratio of the effective image and the aspect ratio of the display screen as shown in FIGS. 8A and 8B. The image format detector 22 controls the image converter 24 to multiply each of the horizontal pixel count and the vertical pixel count of the effective image by the conversion factor K.

More specifically, if the aspect ratio of the effective image as the target image is not equal to the aspect ratio of the display screen, the image format detector 22 determines a horizontal to horizontal ratio H₁/H₂ of the horizontal pixel count H₁ of the display screen to the horizontal pixel count H₂ of the effective image and a vertical to vertical ratio of V₁/V₂ of the vertical pixel count V₁ of the display screen to the vertical pixel count V₂ of the effective image. The image format detector 22 determines as the conversion factor K one of the horizontal to horizontal ratio H₁/H₂ and the vertical to vertical ratio of V₁/V₂ whichever is greater. The image format detector 22 controls the image converter 24 to multiply each of the horizontal pixel count and the vertical pixel count of the effective image by the conversion factor K.

The aspect ratio of the display screen might be 16:9 (=H₁:V₁), and the aspect ratio of the effective image might be 4:3 (=H₂:V₂) as shown in FIG. 8A. Let “a” represent a constant determined by the pixel count of each of the display screen and the effective image, the horizontal to horizontal ratio H₁/H₂ becomes 16/4×a, and the vertical to vertical ratio of V₁/V₂ becomes 9/3×a. The horizontal to horizontal ratio H₁/H₂ is larger than the vertical to vertical ratio of V₁/V₂, and the horizontal to horizontal ratio H₁/H₂ becomes the conversion factor K.

The aspect ratio of the display screen might be 4:3 (=H₁:V₁), and the aspect ratio of the effective image might be 16:9 (=H₂:V₂) as shown in FIG. 8B. Let “b” represent a constant determined by the pixel count of each of the display screen and the effective image, the horizontal to horizontal ratio H₁/H₂ becomes 4/16×b, and the vertical to vertical ratio of V₁/V₂ becomes 3/9×b. The vertical to vertical ratio of V₁/V₂ is larger than the horizontal to horizontal ratio H₁/H₂, and the vertical to vertical ratio of V₁/V₂ becomes the conversion factor K.

The image converter 24 under the control of the image format detector 22 multiplies each of the horizontal pixel count and the vertical pixel count of the effective image as the target image from the reader unit 23 by the conversion factor K. In this way, the effective image is converted into the display image. The display image has one of the horizontal pixel count and the vertical pixel count of the display image equal to one of the horizontal pixel count and the vertical pixel count of the display screen in the corresponding direction, has the size equal to or larger than the screen format of the display screen and being obtained by magnifying the horizontal size and the vertical size of the effective image by the conversion factor K.

If the aspect ratio of the display screen is 16:9 (=H₁:V₁) and the aspect ratio of the effective image is 4:3 (=H₂:V₂) as shown in FIG. 8A, the horizontal to horizontal ratio H₁/H₂ becomes the conversion factor K.

Each of the horizontal pixel count and the vertical pixel count of the effective image of H₂×V₂ is multiplied by the conversion factor K=H₁/H₂. As a result as shown in FIG. 8A, the horizontal pixel count becomes H₁, namely, the horizontal pixel count of the display screen, and the vertical pixel count becomes V₁′ greater than the vertical pixel count V₁ of the display screen. In other words, the display image has the horizontal size equal to the horizontal size H₁ of the display screen, and has the image size equal to or greater than the screen size of the display screen, and being obtained by multiplying each of the horizontal size and the vertical size of the effective image by the conversion factor K=H₁/H₂.

If the aspect ratio of the display screen is 16:9 and the aspect ratio of the effective image is 4:3, the resulting display image has an aspect ratio of 4:3 equal to the aspect ratio of the effective image, the horizontal pixel count equal to the horizontal pixel count H₁ of the display screen and the vertical pixel count V₁′ larger than the vertical pixel count V₁ of the display screen.

If the aspect ratio of the display screen is 4:3 (=H₁:V₁) and the aspect ratio of the effective image is 16:9 (=H₂:V₂), the vertical to vertical ratio of V₁/V₂ becomes the conversion factor K.

Each of the horizontal pixel count and the vertical pixel count of the effective image of H₂×V₂ is multiplied by the conversion factor K=V₁/V₂. As a result as shown in FIG. 8B, the vertical pixel count becomes V₁, namely, the vertical pixel count of the display screen, and the horizontal pixel count becomes H₁′ greater than the horizontal pixel count H₁ of the display screen. In other words, the display image has the vertical size equal to the vertical size V₁ of the display screen, and has the image size equal to or greater than the screen size of the display screen, and being obtained by multiplying each of the horizontal size and the vertical size of the effective image by the conversion factor K=V₁/V₂.

If the aspect ratio of the display screen is 4:3 and the aspect ratio of the effective image is 16:9, the resulting display image has an aspect ratio of 16:9 equal to the aspect ratio of the effective image, the vertical pixel count equal to the vertical pixel count V₁ of the display screen and the horizontal pixel count H₁′ larger than the horizontal pixel count H₁ of the display screen.

If the aspect ratio of the effective image is not equal to the aspect ratio of the display screen, the image converter 24 converts the size of the effective image into the display image. In the resulting display image, one of the horizontal pixel count and the vertical pixel count thereof is equal to one of the horizontal pixel count and the vertical pixel count of the display screen in the one corresponding direction while the other of the horizontal pixel count and the vertical pixel count of the display image is larger than the other of the horizontal pixel count and the vertical pixel count of the display screen in the other corresponding direction. Although the display image is displayed with a horizontal portion or a vertical portion thereof falling outside the display screen of the display 26, the entire display screen of the display 26 is effectively used in terms of utilization of the full screen of the display 26.

Since the display image is obtained by magnifying the horizontal size and the vertical size of the effective image by the same conversion factor K, the aspect ratio of the display image becomes equal to the aspect ratio of the effective image. More specifically, if the effective image is an aspect ratio of 4:3, the display image also has an aspect ratio of 4:3, and if the effective image has an aspect ratio of 16:9, the display image also has an aspect ratio of 16:9. As a result, a subject in the effective image also appears in the display image with an original aspect ratio thereof maintained and in a manner free from distortion.

The image converter 24 performs the size conversion by converting the number of pixels. The pixel count conversion may be performed through an interpolation process or a decimation process. The pixel count conversion may also be performed through a class classification process as proposed by the inventors of this invention. The class classification process will be described in detail later.

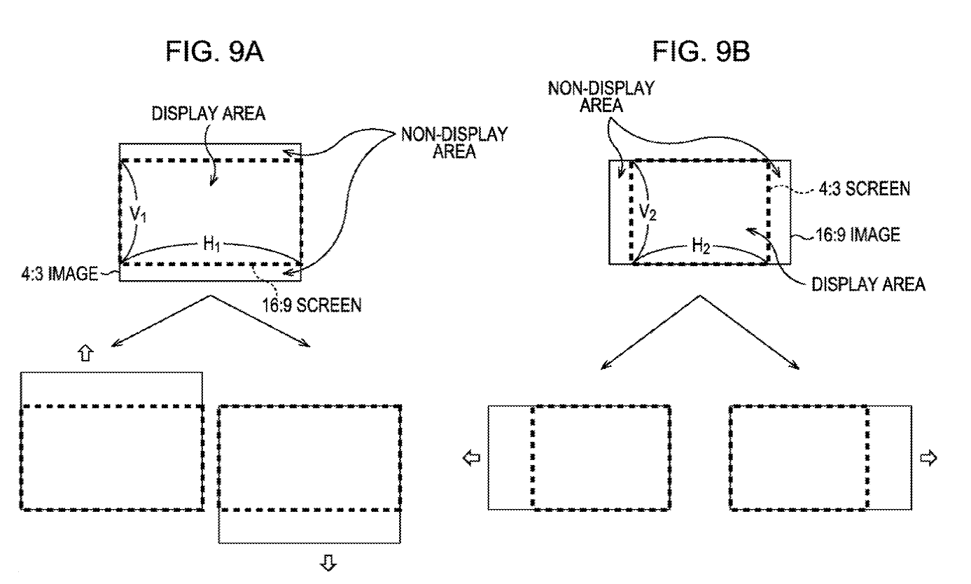

The process of the display controller 25 is described below with reference to FIGS. 9A and 9B and 10.

If the aspect ratio of the effective image is equal to the aspect ratio of the display screen as previously discussed with reference to FIGS. 7A and 7B, the image size of the display image output by the image converter 24 matches the screen size of the display screen of the display 26. The display controller 25 displays the entire display image supplied from the image converter 24 on the entire display screen of the display 26.

If the aspect ratio of the effective image is not equal to the aspect ratio of the display screen as previously discussed with reference to FIGS. 8A and 8B, one of the horizontal pixel count and the vertical pixel count of the display image output by the image converter 24 becomes equal to the pixel count of the display screen in the corresponding direction but the other of the horizontal pixel count and the vertical pixel count become greater than the pixel count of the display screen in the other direction. The display controller 25 cannot display the entire display image from the image converter 24 on the entire display screen of the display 26.

More specifically, if the aspect ratio of the display screen is 16:9 and the aspect ratio of the effective image is 4:3, the resulting display image has an aspect ratio of 4:3 equal to the aspect ratio of the effective image, the horizontal pixel count H₁ equal to the horizontal pixel count of the display screen, and the vertical pixel count greater than the vertical pixel count V₁ of the display screen. If the display image having an aspect ratio of 4:3 is displayed on the display screen having an aspect ratio of 16:9, a top or bottom portion of the display image becomes a non-display area which remains invisible on the display screen as shown in FIG. 9A.

The display controller 25 under the control of the image format detector 22 and the controller 27 scrolls the display image on the display screen of the display 26 in a direction that causes the non-display area to appear.

A portion of the display screen appearing on the display screen is now referred to as a display area. The 4:3 display image appears with the top portion and the bottom portion thereof left invisible as a non-display area. For example, with the display image being scrolled upward, the bottom portion as the non-display area becomes a display area. The user (listener) can now view the bottom portion which was the non-display area. For example, with the display image being scrolled downward, the top portion, which was the non-display area, becomes a display area. The user can now view the top portion that was previously the non-display area.

If the aspect ratio of the display screen is 4:3 and the aspect ratio of the effective image is 16:9, the resulting display image has an aspect ratio of 16:9 equal to the aspect ratio of the effective image, the vertical pixel count V₁ equal to the vertical pixel count of the display screen, and the horizontal pixel count greater than the horizontal pixel count H₁ of the display screen. If the display image having an aspect ratio of 16:9 is displayed on the display screen having an aspect ratio of 4:3, a left or right portion of the display image becomes a non-display area which remains invisible on the display screen as shown in FIG. 9B.

The display controller 25 under the control of the image format detector 22 and the controller 27 scrolls the display image on the display screen of the display 26 in a direction that causes the non-display area to appear.

The 16:9 display image appears with the left portion and the right portion thereof left invisible as a non-display area as shown in FIG. 9B. For example, with the display image being scrolled leftward, the right portion as the non-display area becomes a display area. The user (listener) can now view the right portion which was the non-display area. For example, with the display image being scrolled rightward, the left portion, which was the non-display area, becomes a display area. The user can now view the left portion that was previously the non-display area.

FIG. 10 illustrates the display controller 25 of FIG. 5 performing the scroll process for scrolling the display image on the display screen of the display 26 in a direction that causes the non-display area to come into view.

As shown in FIG. 10, the display controller 25 includes a scroll processor 50. The scroll processor 50 under the control of the image format detector 22 and the controller 27 scrolls the display image on the display screen of the display 26 in the direction that causes the hidden display area to appear.

The scroll processor 50 includes a buffer 51 and a reader unit 52.

The buffer 51 is supplied with the display image from the image converter 24 of FIG. 5. The buffer 51 temporarily stores, by frame (or by field), the display image supplied from the image converter 24.

The reader unit 52 under the control of the image format detector 22 and the controller 27 reads an area of the image size matching the screen size of the display screen of the display 26 out of the display image stored on the buffer 51 and then supplies the read image to the display 26. The display image on the display screen of the display 26 is thus scrolled in the direction that causes the hidden display area to appear.

If the aspect ratio of the effective image equals the aspect ratio of the display screen, the image format detector 22 of FIG. 5 supplies to the reader unit 52 a scroll flag that disables the display image from being scrolled.

If the aspect ratio of the effective image does not equal the aspect ratio of the display screen, the image format detector 22 supplies to the reader unit 52 a scroll flat that enables the hidden display area to appear.

More specifically, if the aspect ratio of the effective image is 4:3 and the aspect ratio of the display screen is 16:9, the image format detector 22 supplies to the reader unit 52 the scroll flag. The scroll flags enables the scroll operation in a vertical direction to reveal the hidden display portion as shown in FIG. 9A.

If the aspect ratio of the effective image is 16:9 and the aspect ratio of the display screen is 4:3, the image format detector 22 supplies to the reader unit 52 the scroll flag. The scroll flag enables the scroll operation in a lateral direction to reveal the hidden display portion as shown in FIG. 9B.

The reader unit 52 receives from the controller 27 a scroll signal indicating the scroll direction represented by the scroll flag from the image format detector 22. In response to the scroll signal, the reader unit 52 reads the display image from the buffer 51, thereby modifying the area of the display image to be supplied to the display 26. The reader unit 52 thus scrolls the display image on the display screen of the display 26.

For example, the controller 27 of FIG. 5 receives from the remote commander 10 an operation signal responsive to an operation of a scroll key 11, and supplies a scroll signal responsive to the operation signal to the reader unit 52.

In response to the scroll signal supplied from the controller 27, the reader unit 52 scrolls the display image on the display screen of the display 26.

If the aspect ratio of the effective image equals the aspect ratio of the display screen, the buffer 51 stores the display image having the image size equal to the image size of the display screen of the display 26. The reader unit 52 reads the entire display image from the buffer 51, and supplies the read display image to the display 26. The entire display image is displayed on the entire display screen.

The process of the display processing apparatus 20 of FIG. 5 is described below with reference to a flowchart of FIG. 11.

The buffer 21 is supplied with data containing an image, such as data broadcast via terrestrial broadcasting service. The buffer 21 temporarily stores the data.

In step S11, the image format detector 22 detects the image format of the image contained in the data stored on the buffer 21. Processing proceeds to step S12.

In step S12, the image format detector 22 recognizes an effective image of the image contained in the data stored on the buffer 21 and then supplies information regarding the effective image to the reader unit 23. Processing proceeds to step S13.

In step S13, the image format detector 22 determines the horizontal to horizontal ratio H₁/H₂ of the horizontal pixel count H₁ of the display screen to the horizontal pixel count H₂ of the effective image and the vertical to vertical ratio V₁/V₂ of the vertical pixel count V₁ of the display screen to the vertical pixel count V₂ of the effective image based on the image format and the screen format of the display screen of the display 26. The image format detector 22 determines as the conversion factor K one of the horizontal to horizontal ratio H₁/H₂ and the vertical to vertical ratio V₁/V₂ whichever is greater (if the two ratios are equal to each other, either one will do). The image format detector 22 supplies information representing the conversion factor K to the image converter 24. Processing proceeds to step S14.

In step S14, the image format detector 22 sets a scroll flag based on the image format and the screen format.

If the aspect ratio of the effective image is equal to the aspect ratio of the display screen, the image format detector 22 sets information representing disabling the scroll of the display image for the scroll flag.

If the aspect ratio of the effective image is not equal to the aspect ratio of the display screen, the image format detector 22 sets, for the scroll flag, information representing enabling of the scroll of the display image in a direction that causes the hidden display area to be revealed.

The image format detector 22 supplies the scroll flag to the display controller 25. Processing proceeds to step S15.

In step S15, the reader unit 23 starts reading the effective image from the buffer 21 in response to information representing the effective image supplied in step S12 from the image format detector 22. The reader unit 23 supplies the image converter 24 with the effective image as a target image to be size converted. Processing proceeds to step S16.

In step S16, the image converter 24 starts the size conversion process based on the information representing the conversion factor K supplied in step S13 from the image format detector 22. In the size conversion process, the effective image input as a target image from the reader unit 23 is converted into the display image by multiplying the horizontal pixel count and the vertical pixel count of the effective image by the conversion factor K.

In step S17, the display controller 25 starts a display control process to cause the display 26 to display the display image supplied from the image converter 24. Processing proceeds to step S18.

In the scroll processor 50 (FIG. 10) forming the display controller 25, the buffer 51 starts storing the display image supplied from the image converter 24, and the reader unit 52 reads the display image stored on the buffer 51, and then starts supplying the read display image to the display 26.

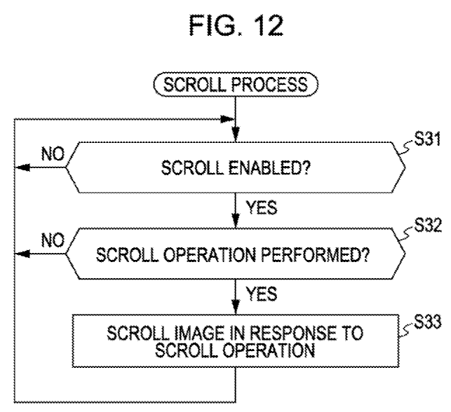

In step S18, the display controller 25 starts the scroll process. Processing proceeds to step S19. The scroll process will be described later with reference to FIG. 12.

In step S19, the image format detector 22 determines whether the image format of the image stored on the buffer 21 has changed.

More specifically, the image format detector 22 constantly monitors the image format of the image stored on the buffer 21. In step S19, the image format detector 22 determines whether or not the image format of the image stored on the buffer 21 has changed.

If it is determined in step S19 that the image format of the image stored on the buffer 51 has not changed, processing returns to step S19.

If it is determined in step S19 that the image format of the image stored on the buffer 51 has changed, processing returns to step S12. Using a new image format, the above-described process is repeated.

The scroll process of the display controller 25 (FIG. 10) started in step S18 of FIG. 11 is described below with reference to a flowchart of FIG. 12.

In step S31 in the scroll process, the reader unit 52 in the scroll processor 50 (FIG. 10) in the display controller 25 determines whether the display image is enabled to be scrolled. This determination is performed based on the scroll flag supplied in step S14 of FIG. 11 from the image format detector 22 (FIG. 5).

If it is determined in step S31 that the scrolling is not enabled, i.e., if the scroll flag indicates that the scrolling of the display image is disabled, processing returns to step S31.

If it is determined in step S31 that the scrolling is enabled, i.e., if the screen format indicates that the scrolling of the display image in the direction to reveal the non-display area thereof is enabled, processing proceeds to step S32. The reader unit 52 determines whether a scroll operation has been performed.

If it is determined in step S32 that the scroll operation has not been performed, processing returns to step S31.

When a user operates the scroll key 11 on the remote commander 10 (FIG. 5), the display controller 25 receives the operation signal responsive to the user operation. The scroll signal responsive to the operation signal is then supplied from the controller 27 to the reader unit 52 in the scroll processor 50 in the display controller 25. Through those steps, the scroll operation is performed. If it is determined in step S32 that the scroll operation has been performed, processing proceeds to step S33. The reader unit 52 modifies a position (range) of the display image read from the buffer 51 in response to the scroll signal from the controller 27. The reader unit 52 thus scrolls the display image on the display 26. Processing returns to step S31.

In accordance with the image format and the screen format, the effective image is converted into the display image. The display image has one of the horizontal size and the vertical size thereof equal to one of the horizontal size and the vertical size of the display screen, and has the image size which is equal to or greater than the image size of the display screen of the display 26 and which is obtained by magnifying the horizontal size and the vertical size of the effective image by the same magnification. The display image displayed on the display 26 is scrolled so that the non-display area of the display image is revealed. The entire display image is thus displayed without deforming the subject in the display image using effectively the entire display screen of the display 26.

The image format detector 22 detects the image format from the broadcast data in accordance with the present embodiment if the image format is contained in the broadcast data. Alternatively, the image format detector 22 may detect a ratio of the horizontal pixel count to the vertical pixel count of the effective image as an aspect ratio of the effective image in the image format.

The ratio of the horizontal pixel count to the vertical pixel count precisely represents the aspect ratio of the image on the premise that each pixel has equal horizontal and vertical lengths. The aspect ratio, which is typically slightly different from content to content, is detected by detecting the ratio of the horizontal pixel count to the vertical pixel count of the effective image.

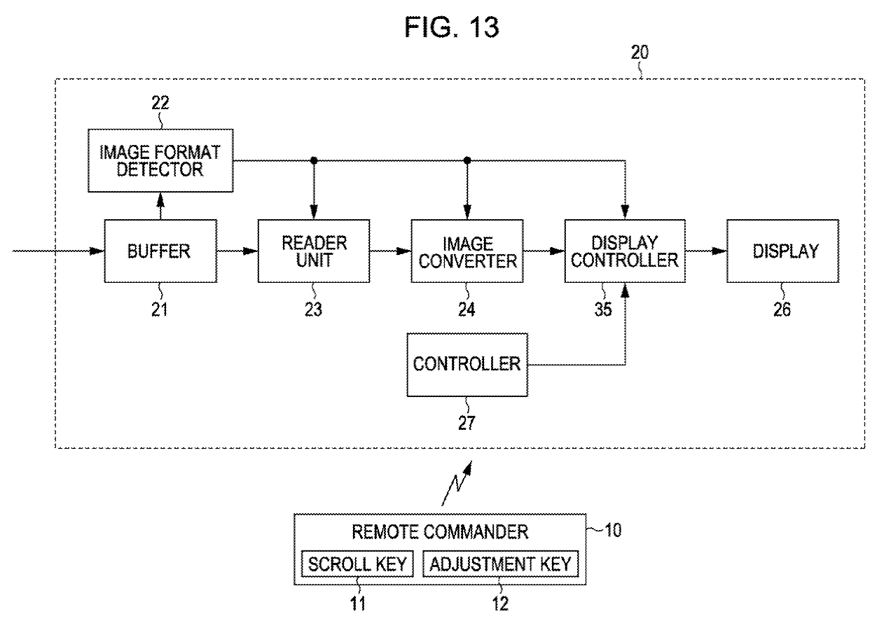

FIG. 13 illustrates another display system in accordance with one embodiment of the present invention.

Elements identical to those illustrated in FIG. 5 are designated with the same reference numerals and the discussion thereof is omitted as appropriate.

The display system of FIG. 13 includes the remote commander 10 having an adjustment key 12. The display processing apparatus 20 includes a display controller 35 instead of the display controller 25. The rest of the display system of FIG. 13 is identical to the display system of FIG. 5.

The adjustment key 12 in the remote commander 10 is operated by the user to adjust a blending ratio to be discussed later. The remote commander 10 transmits to the controller 27 an operation signal responsive to a user operation applied to the adjustment key 12.

As the display controller 25 of FIG. 5, the display controller 35 causes the display 26 to display the display image from the image converter 24. The display controller 35 under the control of the image format detector 22 and the controller 27 scrolls the display image on the display 26 and further performs a ticker process to display a ticker such as a caption.

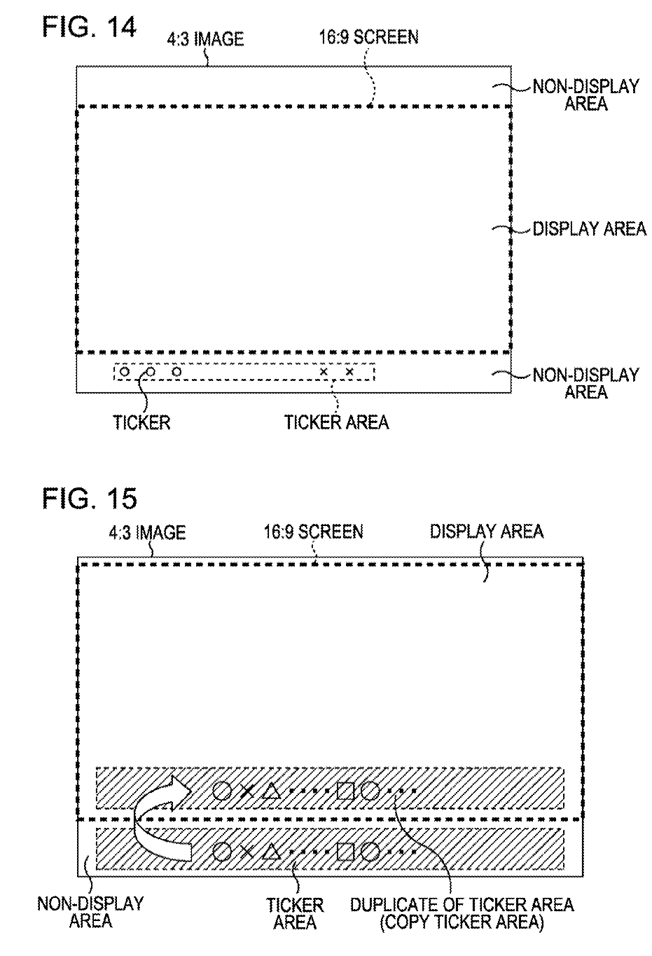

The ticker process is described below with reference to FIGS. 14 through 20.

If the aspect ratio of the display screen of the display 26 is 16:9 and the aspect ratio of the effective image is 4:3 as shown in FIG. 9A, the image converter 24 generates the display image that has an aspect ratio of 4:3 equal to the aspect ratio of the effective image, the horizontal pixel count equal to the horizontal pixel count of the display screen and the vertical pixel count greater than the vertical pixel count of the display screen. When such a display image having an aspect ratio of 4:3 is displayed on the display screen having an aspect ratio of 16:9, one of the top portion and the bottom portion of the display image remains hidden as shown in FIG. 9A.

The user can view a subject in the non-display area of the display area by performing the scroll operation using the remote commander 10. If a ticker falls within the non-display area, such a ticker may escape the user's attention. The user may not bother to scroll the display area and end operation not knowing even the presence of the ticker.

FIG. 14 illustrates the display image displayed on the display screen of the display 26.

As shown in FIG. 14, the display image has an aspect ratio of 4:3 equal to the aspect ratio of the effective image, the horizontal pixel count equal to the horizontal pixel count of the display screen and the vertical pixel count greater than the vertical pixel count of the display image. The same display image has already been shown in FIG. 9A. As a result, one of the top portion and the bottom portion of the display image remains hidden.

As shown in FIG. 14, a ticker in the bottom portion remains hidden.

In this display image, a smallest possible rectangular shape surrounding the ticker is hereinafter referred to as a ticker area.

When the portion containing the ticker is a non-display area as shown in FIG. 14, the user needs to scroll the display image upward by performing the scroll operation on the remote commander 10 (FIG. 13) in order to view the ticker. It is difficult for the user unaware of the presence of the ticker in the display area to perform the scroll operation.

The display controller 35 of FIG. 13 determines whether the ticker area is present within the non-display area of the display image. If it is determined that the ticker area is present within the non-display area of the display image, the display controller 35 performs a ticker process by blending the ticker area in the non-display area with a blend area as part of the display area of the display image on the display screen of the display 26 in accordance with a predetermined blending ratio (so-called α blending).

Let P represent the pixel count of the ticker area, Q represent the pixel count of the blend area, and α represent a predetermined blending ratio, and the display controller 35 blends the ticker area with the blend area according to equation P×α+Q×(1−α).

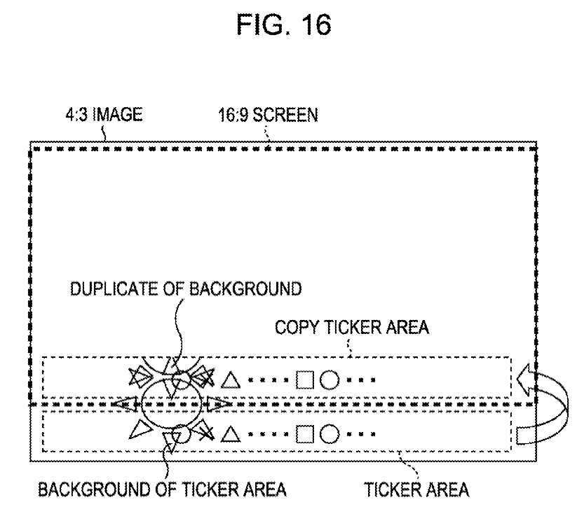

The ticker process of the display controller 35 is generally described with reference to FIGS. 15 and 16.

The display controller 35 determines whether the ticker area is present in the non-display area of the display image. If it is determined that the ticker area is present in the non-display area, the display controller 35 copies the ticker area in the non-display area. FIG. 15 illustrates a blend area as close as possible to the ticker area. A copy of the ticker area as the entire copy ticker area is displayed on the blend area. The display controller 35 blends the copy ticker area with the blend area with a predetermined blending ratio.

By blending the copy ticker area to the blend area close to the ticker area of the display area, the blend area is thus prevented from appearing unnatural subsequent to blending.

FIG. 16 diagrammatically illustrates the display image in which the copy ticker area is blended to the blend area arranged to be as close as possible to the ticker area of the display area.

When the copy ticker area is blended with the blend area of the display area, an image (background) other than the ticker in the copy ticker area is blended with an image in the blend area.

With the blend area arranged to be as close as possible to the ticker area, the image other than the ticker in the copy ticker area and the image in the blend area are relatively similar to each other. In particular, when the image is a landscape image, the display area resulting from blending the copy ticker area is prevented from appearing unnatural.

The user can adjust the blending ratio for blending the copy ticker area to the blend area by operating the adjustment key 12 (FIG. 13). More specifically, the display controller 35 (ticker area blender 64 of FIG. 19 to be discussed later) blends the copy ticker area with the blend area according to the blending ratio responsive to the user operation applied on the adjustment key 12.

For example, the ticker is set to be easy to view by adjusting the blending ratio to expand the copy ticker area.

The display controller 35 may blend the copy ticker area with the blend area according to the blending ratio responsive to the distance between the ticker area in the non-display area and the blend area.

More specifically, the display controller 35 blends the copy ticker area with the blend area according to the blending ratio. In this case, the blending ratio is determined so that the shorter the distance between the ticker area in the non-display area and the blend area, the larger the ratio of the copy ticker area becomes, and so that the longer the distance between the ticker area in the non-display area and the blend area, the larger the ratio of the blend area becomes.

The blending ratio for blending the copy ticker area with the blend area may be determined by operating the adjustment key 12 (hereinafter referred to as a first blending ratio), or may be determined in response to the distance between the ticker area in the non-display area and the blend area (hereinafter referred to as a second blending ratio). Alternatively, the blending ratio may be determined by averaging the first blending ratio and the second blending ratio or averaging the first blending ratio and the second blending ratio with predetermined weights.

The ticker area in whole or in part may be present within the blend area depending on the scroll state of the display image or the position of the ticker in the effective image. If the ticker area is blended with the blend area in this case, the ticker present within the blend area may overlap the ticker within the copy ticker area. The ticker can be less viewable.

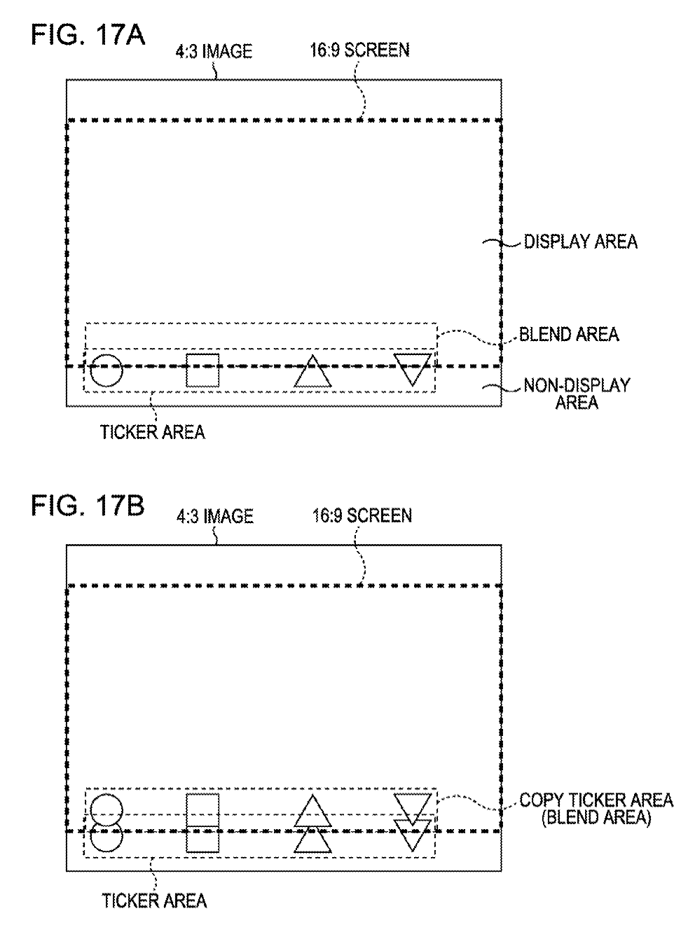

FIGS. 17A and 17B illustrate a display image in which the ticker area is partly present both in the non-display area and the display area.

If the ticker area is present both in the non-display area and the display area, the blend area close to the ticker area overlaps the ticker area present within the display area as shown in FIG. 17A.

If the copy ticker area is blended with the blend area with the blend area overlapping the ticker area present within the display area, the ticker in the ticker area present within the display area overlaps the ticker in the copy ticker area as shown in FIG. 17B. The ticker becomes less viewable.

The display controller 35 determines whether the ticker area is present within the non-display area, and further determines whether the ticker area is present within the blend area to be blended with the copy ticker area. If the ticker area is present in the non-display area and the blend area as part of the display area, the display controller 35 scrolls the display image on the display 26 so that the entire ticker area present within the blend area is contained in the display area or in the non-display area.

The presence of the ticker area in the blend area can cause the ticker in the ticker area present within the blend area to overlap the ticker within the copy ticker area, thereby causing the ticker less viewable. The above arrangement prevents the ticker from becoming less viewable.

When the ticker area is present within the blend area, the display controller 35 scrolls the display image so that the entire ticker area is contained in the display area or non-display area. This operation is referred to as an automatic scroll process.

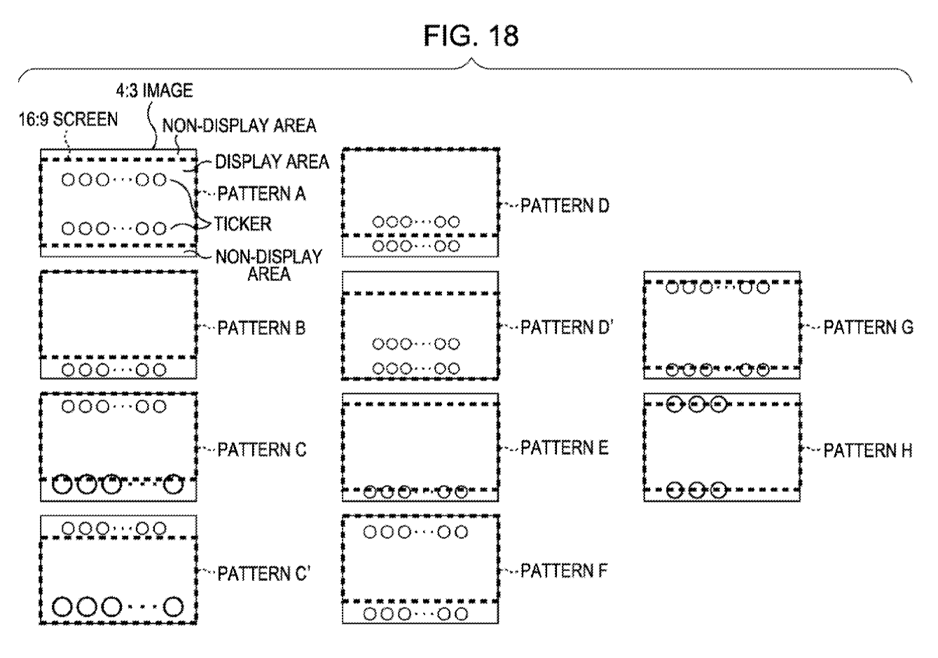

FIG. 18 illustrates the automatic scroll process.

FIG. 18 illustrates patterns in which the ticker area is present within the display image.

In a pattern A, the ticker area is present within only the display area. Since the ticker area is not present within the non-display area in the pattern A, no automatic scroll process is required.

In a pattern B, the ticker area is present within only the non-display area. Since the ticker area is present within only the non-display area, no automatic scroll process is performed.

In a pattern C, the ticker area is present within both the top side and the bottom side of the display image. The ticker is present on the top side and the bottom side of the display image. The ticker area is present in the non-display area and a portion of the display area close to the ticker area, namely, in the blend area. In such a case, the display controller 35 performs the automatic scroll process so that the ticker area is not present within the blend area. More specifically, the upper ticker area is contained in only the non-display area, and the lower ticker area is contained in only the display area as shown in a pattern C′.

In a pattern D, two rows of ticker area are present in the lower portion of the display image. The first row of ticker area is present in the display area and the second row of ticker area is present in the non-display area. More specifically, in the pattern D, the first row of ticker area is present in the blend area as an area close to the second ticker area present within the non-display area. The display controller 35 performs the automatic scroll process to cause the ticker area not to be present as shown in a pattern D′. The automatic scroll process is performed to scroll the display image upward so that the two rows of ticker area are contained in only the display area.

In a pattern E, the ticker area is present on the lower side of the display image. The ticker area is present in the non-display area and in the blend area as an area close to the ticker area. The display controller 35 performs the automatic scroll process so that the ticker area is not present in the blend area. More specifically, the display image is scrolled upward so that the ticker area is contained only in the display area or is scrolled downward so that the ticker area is contained only in the non-display area.

In a patter F, the ticker area is present on the top side and the bottom side of the display image. The upper ticker area is present only in the display area. The lower ticker area is present only in the non-display area. Since the ticker area is not present both in the non-display area and the blend area in the pattern F, the automatic scroll process is not performed.

In a pattern G, the ticker area is present on the top side and the bottom side of the display image. The upper ticker area is present both in the non-display area and the blend area of the display area. The lower ticker area is also present both in the non-display area and the blend area. The display controller 35 performs the automatic scroll process to cause the ticker area not to be present in the blend area. More specifically, the display image is scrolled upward so that the upper ticker area is contained only in the non-display area and the lower ticker area is contained only in the display area. When the display image of the pattern G is scrolled upward in this way, the resulting pattern of the ticker area becomes identical to the pattern C′.

In the pattern G, the display controller 35 can also perform the automatic scroll process in a downward direction to cause the ticker area not to be present in the blend area. More specifically, the display image is scrolled downward so that the upper ticker area is contained only in the display area and so that the lower ticker area is contained only in the non-display area. If the display image of the pattern G is scrolled downward, the resulting ticker area becomes the pattern F.

In a pattern H, the ticker area is present on the top side and the bottom side of the display image. As in the pattern G, the upper ticker area is present in the non-display area and the blend area and the lower ticker area is present in the non-display area and the blend area.

In the pattern H, however, the ticker is large and the ticker area is also large accordingly. The scroll process in either direction causes one of the upper ticker area and the lower ticker area to be present in both the non-display area and the blend area. Scrolling the display image in a manner to cause the ticker area not to be present in the blend area is difficult.

When scrolling the display image in a manner to cause the ticker area not to be present in the blend area is difficult, the display controller 35 performs an exception process instead of the automatic scroll process.

The exception processes may include a process of determining a method of displaying the copy ticker area in response to the user operation performed on the remote commander 10 (FIG. 13), a process of cross-fading the copy ticker area, and a process of blending the copy ticker area with a blending ratio of 1.0.

FIG. 19 illustrates the display controller 35 of FIG. 13 performing the ticker process in addition to the scroll process.

As shown in FIG. 19, elements identical to those used in the display controller 25 of FIG. 10 are designated with the same reference numerals and the discussion thereof is omitted as appropriate.

As shown in FIG. 19, the display controller 35 includes a ticker processor 60 in addition to the scroll processor 50. The ticker processor 60 performs the ticker process.

The ticker processor 60 includes a buffer 61, a ticker determiner 62, a ticker area extractor 63 and a ticker area blender 64.

The buffer 51 receives the display image from the image converter 24 of FIG. 13. The buffer 51 temporarily stores the display image supplied from the image converter 24 as the buffer 51 in the scroll processor 50.

The buffer 51 in the scroll processor 50 and the buffer 61 in the ticker processor 60 store the same display image. One buffer may be commonly used as the buffer 51 in the scroll processor 50 and the buffer 61 in the ticker processor 60.

The ticker determiner 62 references the display image stored on the buffer 61. The ticker determiner 62 then determines whether the ticker area is present in the non-display area, and further determines whether the ticker area is present in the blend area, namely, part of the display area with which the ticker area is blended, or an area close to the ticker area. Depending on the determination results, the ticker determiner 62 controls the ticker area extractor 63 and the reader unit 52 in the scroll processor 50.

The ticker determiner 62 is designed to receive the scroll signal from the controller 27 (FIG. 13). In response to the scroll signal, the ticker determiner 62 recognizes the scroll state of the display image displayed on the display 26.

Based on the scroll state of the display image and the display image stored on the buffer 61, the ticker determiner 62 determines whether the ticker area is present within the non-display area in the display image displayed on the display 26, and the ticker determiner 62 further determines whether the ticker area is present within the blend area. If it is determined that the ticker area is present in the display image displayed on the display 26, the ticker determiner 62 determines the pattern of the ticker area. If the pattern of the ticker area is one of patterns C, D, E and G of FIG. 18, i.e., if the ticker area is present both in the non-display area and the blend area, the ticker determiner 62 generates the scroll signal for scrolling the display image and supplies the scroll signal to the reader unit 52.

If the pattern of the ticker area is one of patterns A, B and F of FIG. 18, i.e., if the ticker area is not present both in the non-display area and the blend area, the scroll signal supplied from the controller 27 is directly supplied to the reader unit 52.

If it is determined that the ticker area is present only in the non-display area, the ticker determiner 62 instructs the ticker area extractor 63 to extract the ticker area present in the non-display area.

In response to the instruction to extract the ticker area from the ticker determiner 62, the ticker area extractor 63 extracts the ticker area present in the non-display area from the display image stored on the buffer 61, and supplies the copy ticker area as a copy of the ticker area to the ticker area blender 64.

The ticker area blender 64 receives the copy ticker area from the ticker area extractor 63, the blending ratio from the display 26 (FIG. 13), and an area of the image size matching the screen size of the display screen of the display 26 out of the display image stored on the buffer 51, namely, the display area.

If the copy ticker area is not supplied from the ticker area extractor 63, the ticker area blender 64 supplies the display area from the reader unit 52 directly to the display 26 to be displayed.

If the copy ticker area is supplied from the ticker area extractor 63, the ticker area blender 64 blends the copy ticker area from the ticker area extractor 63 with the blend area of the display area from the reader unit 52, namely, an area close to the original copy area of the copy ticker area. The blended display image is then supplied to the display 26 to be displayed thereon.

The display controller 35 thus constructed performs the ticker process in addition to the scroll process performed by the display controller 25 of FIG. 5 as discussed with reference to FIG. 12.

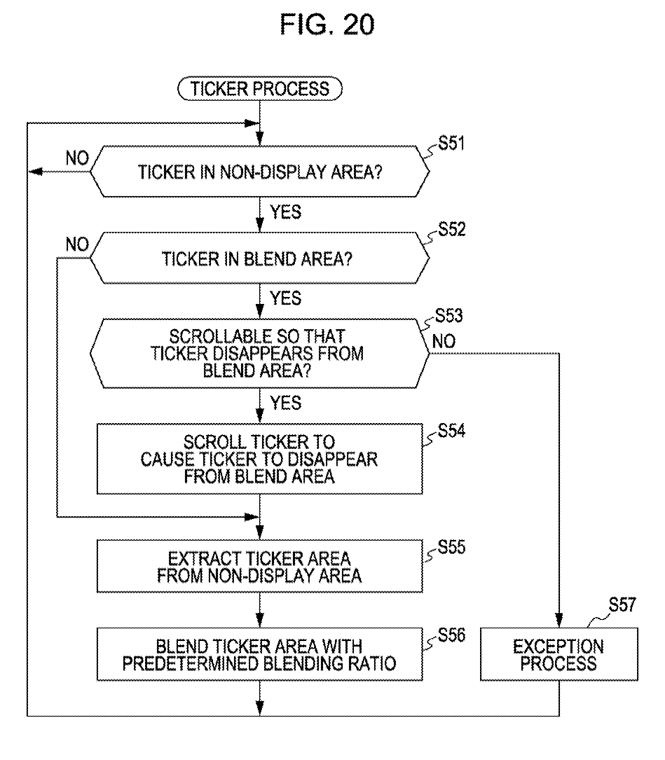

FIG. 20 is a flowchart illustrating the ticker process.

The ticker process is performed in step S18 as the scroll process of FIG. 12.

In step S51 in the ticker process, the ticker determiner 62 references the display image stored on the buffer 61, thereby determining whether the ticker area is present in the non-display area in the display image.

If it is determined in step S51 that no ticker area is present in the non-display area, for example, the ticker area is present only in the display area as shown in the pattern A of FIG. 18, or no ticker area is present in the display image, processing returns to step S51.

The ticker area blender 64 supplies the display area supplied from the buffer 51 directly to the display 26 to be displayed.

If it is determined in step S51 that the ticker area is present in the non-display area, for example, the ticker area is present in the non-display area such as in the case of one of the patterns B, C, D, E, F, G and H of FIG. 18, processing proceeds to step S52. The ticker determiner 62 determines whether the ticker area is present in the blend area.

If it is determined in step S52 that no ticker area is present in the blend area, for example, the ticker area is present in the non-display area but not in the blend area as shown in one of the patterns B and F of FIG. 18, the ticker determiner 62 instructs the ticker area extractor 63 to extract the ticker area present in the non-display area. Processing proceeds to step S55.

In step S55, in response to the instruction from the ticker determiner 62, the ticker area extractor 63 extracts the ticker area present in the non-display area in the display image stored on the buffer 61. The ticker area extractor 63 supplies the copy ticker area as a copy of the ticker area to the ticker area blender 64. Processing proceeds to step S56.

In step S56, according to the blending ratio supplied from the controller 27, the ticker area blender 64 blends the copy ticker area supplied from the ticker area extractor 63 with the blend area as an area close to an original copy area of the copy ticker area, and then supplies the blended display area to the display 26. Processing returns to step S51.

If it is determined in step S52 that the ticker area is present in the blend area, i.e., the ticker area is present both in the non-display area and the blend area as shown in one of the patterns C, D, E, G and H of FIG. 18, processing proceeds to step S53. The ticker determiner 62 determines whether the display image is scrollable to the state that the ticker area is not present in the blend area.

If it is determined in step S53 that the display image is scrollable to the state that the ticker area is not present in the blend area, i.e., the ticker area is present both in the non-display area and the blend area but the display image is scrollable to the state that the ticker area is not present in the blend area as shown in one of the patterns C, D, E and G, processing proceeds to step S54. The ticker determiner 62 supplies the scroll signal for scrolling the display image to the reader unit 52.

In response to the scroll signal from the ticker determiner 62, the reader unit 52 modifies the position (range) of the display image read from the buffer 51. In this way, the display controller 35 performs the automatic scroll process, thereby scrolling the display image on the display 26 to the state that the ticker area is not be present in the blend area.

If the ticker area is present in the non-display area but not in the blend area as a result of the automatic scroll process in step S54 as shown in one of the patterns B, C′ and F of FIG. 18, processing proceeds to step S55. The process as the one described above is performed.

If the ticker area is present only in the display area as a result of the automatic scroll process in step S54 as shown in the pattern D′ of FIG. 18, processing returns to step S51 with steps S55 and S56 skipped.

If it is determined in step S53 that the display image is not scrollable to the state that no ticker area is present in the blend area, i.e., scrolling the display image in any direction cannot result in the state that the ticker area is not present in the blend area as shown in the pattern D′ of FIG. 18, processing proceeds to step S57. The display controller 35 performs the exception process. Processing returns to step S51.

The display controller 35 thus determines whether the ticker area is present in the non-display area. If it is determined that the ticker area is present in the non-display area, the ticker area (copy ticker area) is blended with the blend area close to the ticker area according to a predetermined blending ratio. The size conversion performed by the image converter 24 (FIG. 13) easily causes the ticker present in the non-display area to appear in the display area.

The area close to the ticker area is set to be the blend area, and the ticker area is blended with the blend area. The display area with the ticker area blended with the blend area is prevented from becoming unnatural in appearance.

Since the ticker area containing the ticker is extracted, the process is simplified in comparison with a process in which the ticker itself is extracted.

If the ticker area is present in the blend area, the ticker process is performed in succession to the automatic scroll process. Through the automatic scroll process, the ticker area is set not to be present in the blend area, and then the ticker area is blended. This arrangement controls the appearance of an illegible ticker that might be caused when the ticker area is blended with the blend area that has already contained the ticker area.

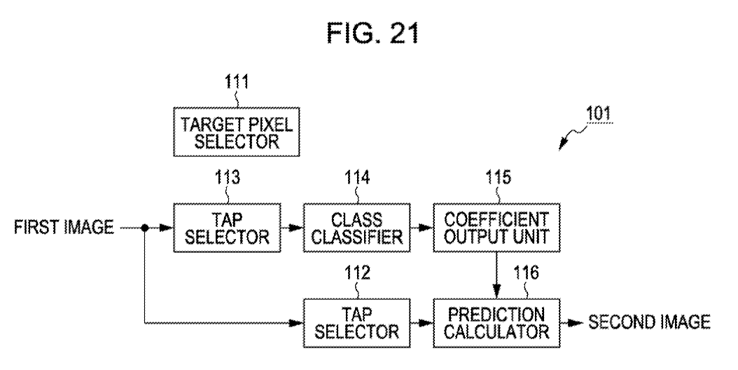

The size conversion performed by the image converter 24 (FIGS. 5A-5D and 13) is a pixel count conversion. The pixel count conversion may be performed by the interpolation process, the decimation process, or the class classification process. With reference to FIGS. 21 through 31, the class classification process is described below.

As an example of the class classification process, an image conversion process for converting first image data (image signal) into second image data (image signal) is described below.

The image conversion process for converting the first image data into the second image data can take one of a variety of signal processes depending on the definition of the first and second image data.

For example, if the first image data is image data of a low spatial resolution and the second image data is image data of a high spatial resolution, the image conversion process is a spatial resolution improvement process intended to improve spatial resolution.

If the first image data is image data of a low signal-to-noise (S/N) ratio and the second image data is image data of a high S/N ratio, the image conversion process is a noise reduction process intended to reduce noise.

If the first image data is image data having a predetermined pixel count (image size) and the second image data is image data having more or less pixel count, the image conversion process is a resize process intended to resize an image (for scale expansion or scale contraction).

If the first image data is image data having a low time resolution and the second image data is image data having a high time resolution, the image conversion process is a time resolution improvement process intended to improve time resolution.

If the first image data is image data obtained by decoding image data coded by block through moving picture experts group (MPEG), and the second image data is image data prior to coding, the image conversion process is a distortion removal process intended to remove a variety of distortions including block distortion caused in MPEG encoding and decoding.

In the spatial resolution improvement process, the first image data as the low spatial resolution image data is converted into the second image data as the high spatial resolution image data. In this case, the second image data may have the same pixel count as the first image data, or may have more pixel count than the first image data. If the second image data has a pixel count more than that of the first image data, the spatial resolution improvement process is not only to improve spatial resolution but also to resize an image size (pixel count).

In this way, the image conversion process can take one of the variety of signal processes depending on the definition of the first image data and the second image data.

In the class classification process as the image conversion process, a target pixel (value) in the second image data is classified into one of a plurality of classes according to a predetermined rule, a tap coefficient is determined from thus obtained class, and a pixel (value) in the first image data is selected for the target pixel. The target pixel (value) is thus calculated using the tap coefficient and the pixel (value) in the first image data.

FIG. 21 illustrates the structure of an image conversion apparatus 101 performing the image conversion process using the class classification process.

In the image conversion apparatus 101, as shown in FIG. 21, the first image data is supplied to each of a tap selector 112 and a tap selector 113.

A target pixel selector 111 successively sets each pixel forming the second image data as a target pixel, and then supplies information regarding the target pixel to a required block.

The tap selector 112 selects, as predictive taps, (values of) several pixels forming the first image data used to predict (the value of) the target image.

More specifically, the tap selector 112 selects, as predictive taps, a plurality of pixels in the first image data placed closest in time or space to the position of the target pixel in time and space.

The tap selector 113 selects, as class taps, several pixels forming the first image data used to classify the target pixels into each of the classes according to a predetermined rule. More specifically, the tap selector 113 selects the class tap in the same way as the tap selector 112 selects the predictive tap.

The predictive tap and the class tap may have the same tap structure (position relationship with respect to the target pixel), or may have different tap structures.

The predictive tap obtained by the tap selector 112 is supplied to a prediction calculator 116. The class tap obtained by the tap selector 113 is supplied to a class classifier 114.

The class classifier 114 classifies the target pixels according to the class tap supplied from the tap selector 113, and supplies a class code responsive to the obtained class to a coefficient output unit 115.

The class classification method may be the one disclosed in Adaptive Dynamic Range Coding (ADRC).

In accordance with the method used in ADRC, (the value of) the pixel is ADRC processed, and the class of the target pixel is determined based on the resulting ADRC code.

In K bit ADRC, a maximum value MAX and a minimum value MIN of the pixel value of the pixel forming the class tap are detected, and DR=MAX−MIN is used as localized dynamic range of a set. Based on the dynamic range DR, the pixel value of each pixel forming the class tap is re-quantized into K bits. More specifically, the minimum value MIN is subtracted from the pixel value of the pixel forming the class tap, and the resulting difference is then divided (re-quantized) by DR/2^{K}. The K bit pixel values of the pixels forming the class tap are arranged into a bit train in accordance with a predetermined order. The bit train is output as the ADRC code. For example, when the class tap is 1 bit ADRC processed, the pixel value of the pixel forming the class tap is divided by the mean value of the maximum value MAX and the minimum value MIN (with fractions rounded). The pixel value of each pixel becomes 1 bit (binarized). The bit train containing 1 bit pixel values arranged in a predetermined order is output as the ADRC code.

The class classifier 114 can output, as a clad code, a pattern of level distribution of the pixel values of the pixels forming the class tap. If the class tap is composed of the pixel values of the N pixels with the pixel value of each pixel assigned with K bits, the class code output from the class classifier 114 is (2^{N})^{K}. The class code thus becomes an enormous value that is K-th power to the pixel value of the pixel.

The class classifier 114 preferably class classifies an amount of information of class tap rather than compressing the amount of information of the class tap through the ADRC process or vector quantization process.

The coefficient output unit 115 stores the tap coefficient of each class determined through a learning process to be discussed later. The coefficient output unit 115 further outputs the tap coefficient at an address corresponding to a class code supplied from the class classifier 114 (the tap coefficient of the class represented by the class code supplied from the class classifier 114), out of the stored tap coefficients. That tap coefficient is supplied to the prediction calculator 116.

The tap coefficient corresponds to a coefficient to be multiplied by input data in a tap of a digital filter.

The prediction calculator 116 acquires the predictive tap output from the tap selector 112 and the tap coefficient output from the coefficient output unit 115. Using the predictive tap and the tap coefficient, the prediction calculator 116 performs a prediction calculation to determine a predictive value of a true value of the target pixel. The prediction calculator 116 thus determines and outputs (the predictive value of) the pixel value of the target pixel, namely, the pixel value of the pixel forming the second image data.

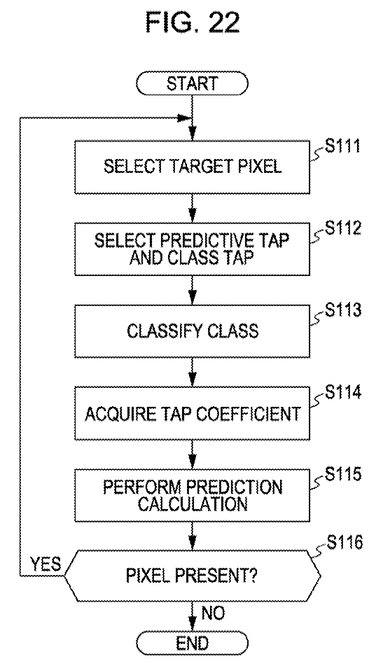

The image conversion process of the image conversion apparatus 101 of FIG. 21 is described below with reference to FIG. 22.

In step S111, the target pixel selector 111 selects as a target pixel one of the pixels not yet selected as a target pixel and forming the second image data responsive to the first image data input to the image conversion apparatus 101. More specifically, the target pixel selector 111 selects, in a raster scan order, as a target pixel one of the pixels not yet selected as a target pixel and forming the second image data. Processing proceeds to step S112.

In step S112, the tap selector 112 and the tap selector 113 select, from the first image data, the predictive tap and the class tap of the target pixel, respectively. The predictive tap is supplied from the tap selector 112 to the prediction calculator 116. The class tap is supplied from the tap selector 113 to the class classifier 114.

The class classifier 114 receives the class tap of the target pixel from the tap selector 113. In step S113, the class classifier 114 class classifies the target pixel according to the class tap. The class classifier 114 outputs to the coefficient output unit 115 the class code representing the class of the target pixel obtained as a result of class classification. Processing proceeds to step S114.

In step S114, the coefficient output unit 115 acquires (reads) and output the tap coefficient stored at the address responsive to the class code supplied from the class classifier 114. Furthermore in step S114, the prediction calculator 116 acquires the tap coefficient output from the coefficient output unit 115. Processing proceeds to step S115.

In step S115, the prediction calculator 116 performs the predetermined prediction calculation using the predictive tap output from the tap selector 112 and the tap coefficient acquired from the coefficient output unit 115. The prediction calculator 116 determines and outputs the pixel value of the target pixel. Processing proceeds to step S116.

In step S116, the target pixel selector 111 determines whether the second image data has a pixel not yet selected as a target pixel. If it is determined in step S116 that the second image data contains a pixel not yet selected as a target pixel, processing returns to step S111. The same process as described above is repeated.

If it is determined in step S116 that the second image data does not contain a pixel not yet selected as a target pixel, processing thus ends.

The prediction calculation of the prediction calculator 116 and the tap coefficient learning process of the coefficient output unit 115 of FIG. 21 are described below.

The second image data is high definition image data and the first image data is low definition image data that is lowered in definition by low-pass filtering the high definition image data. The predictive tap is selected from the low definition image data. Using the predictive tap and the tap coefficient, the pixel value of the pixel of the high definition image data is determined through the predetermined prediction calculation process.

The predetermined prediction calculation process is now a linear prediction calculation. Pixel value y of a high definition pixel is determined by the following linear equation (1):

$$y = {\sum }_{n = 1}^{N} {w}_{n} {x}_{n} \qquad ( 1 )$$

where xₙ is a pixel value of an n-th pixel of the low definition image data (hereinafter referred to as low definition pixel) forming the predictive tap relating to the high definition pixel y, and wₙ is a n-th tap coefficient to be multiplied by (the pixel value of) the n-th low definition pixel. In equation (1), the predictive tap is composed of N low definition pixels x₁, x₂, . . . , x_{N}.

The pixel value y of the high definition pixel is may be determined using a higher order equation such as a quadratic equation rather than the linear equation.

Let yₖ represent a true value of the pixel value of a high definition pixel of k-th sample, and yₖ′ represent a predictive value of the true value yₖ obtained from equation (1), and a predictive error eₖ of the predictive value yₖ′ is expressed by equation (2):

eₖ=yₖ−yₖ′ (2)

The predictive value yₖ′ is calculated using equation (1). When equation (2) is reorganized in accordance with the predictive value yₖ′ in accordance with equation (1), the following equation (3) is obtained:

$${e}_{k} = {y}_{k} - ( {\sum }_{n = 1}^{N} {w}_{n} {x}_{n , k} ) \qquad ( 3 )$$

where x_{n,k} represents a n-th low definition image forming the predictive tap of the high definition pixel of the k-th sample.

A tap coefficient wₙ causing the predictive error eₖ in equation (3) (or equation (2)) to be zero is optimum for predicting the high definition pixel. It is generally difficult to determine such tap coefficients wₙ for all high definition pixels.

The least squares method may be used to determine optimum tap coefficient wₙ. The optimum tap coefficient wₙ may be determined by minimizing the sum E of squared error expressed by the following equation (4):

$$E = {\sum }_{k = 1}^{K} {e}_{k}^{2} \qquad ( 4 )$$

where K represents the number of samples of a set of the high definition pixel yₖ and low definition pixels x₁ₖ, x₂ₖ, . . . , x_{Nk} forming the predictive tap of the high definition pixel yₖ (namely, the number of learning samples).

As expressed in equation (5), the minimum value of the total sum E of the squared errors of equation (4) is determined by partial differentiating the total sum E by the tap coefficient wₙ and by making the result equal to zero.

$$\frac{\partial E}{\partial {w}_{n}} = {e}_{1} \frac{\partial {e}_{1}}{\partial {w}_{n}} + {e}_{2} \frac{\partial {e}_{2}}{\partial {w}_{n}} + … + {e}_{k} \frac{\partial {e}_{k}}{\partial {w}_{n}} = 0 \\ ( n = 1 , 2 , ⋯ , N ) \qquad ( 5 )$$

If equation (3) is partial differentiated by the tap coefficient wₙ, the following equation (6) results:

$$\frac{\partial {e}_{k}}{\partial {w}_{1}} = - {x}_{1 , k} , \frac{\partial {e}_{k}}{\partial {w}_{2}} = - {x}_{2 , k} , ⋯ , \frac{\partial {e}_{k}}{\partial {w}_{N}} = - {x}_{N , k} , \\ ( k = 1 , 2 , ⋯ , K ) \qquad ( 6 )$$

The following equation (7) is obtained from equations (5) and (6):

$${\sum }_{k = 1}^{K} {e}_{k} {x}_{1 , k} = 0 , {\sum }_{k = 1}^{K} {e}_{k} {x}_{2 , k} = 0 , ⋯ {\sum }_{k = 1}^{K} {e}_{k} {x}_{N , k} = 0 \qquad ( 7 )$$

By substituting equation (3) for eₖ in equation (7), equation (7) is expressed by a normal equation (8):

$$[ \begin{matrix}( {\sum }_{k = 1}^{K} {x}_{1 , k} {x}_{1 , k} ) & ( {\sum }_{k = 1}^{K} {x}_{1 , k} {x}_{2 , k} ) & ⋯ & ( {\sum }_{k = 1}^{K} {x}_{1 , k} {x}_{N , k} ) \\ ( {\sum }_{k = 1}^{K} {x}_{2 , k} {x}_{1 , k} ) & ( {\sum }_{k = 1}^{K} {x}_{2 , k} {x}_{2 , k} ) & ⋯ & ( {\sum }_{k = 1}^{K} {x}_{2 , k} {x}_{N , k} ) \\ ⋮ & ⋮ & ⋰ & ⋮ \\ ( {\sum }_{k = 1}^{K} {x}_{N , k} {x}_{1 , k} ) & ( {\sum }_{k = 1}^{K} {x}_{N , k} {x}_{2 , k} ) & ⋯ & ( {\sum }_{k = 1}^{K} {x}_{N , k} {x}_{N , k} )\end{matrix} ] [ \begin{matrix}{w}_{1} \\ \\ \\ {w}_{2} \\ \\ ⋮ \\ \\ {w}_{N}\end{matrix} ] = \\ [ \begin{matrix}( {\sum }_{k = 1}^{K} {x}_{1 , k} {y}_{k} ) \\ ( {\sum }_{k = 1}^{K} {x}_{2 , k} {y}_{k} ) \\ ⋮ \\ ( {\sum }_{k = 1}^{K} {x}_{N , k} {y}_{k} )\end{matrix} ] \qquad ( 8 )$$

The normal equation (8) is solved for the tap coefficient wₙ using sweep method (Gauss-Jordan elimination).

By writing and solving the normal equation (8) for each class, the optimum tap coefficient wₙ (minimizing the total sum E of the squared errors) is determined on a per class basis.

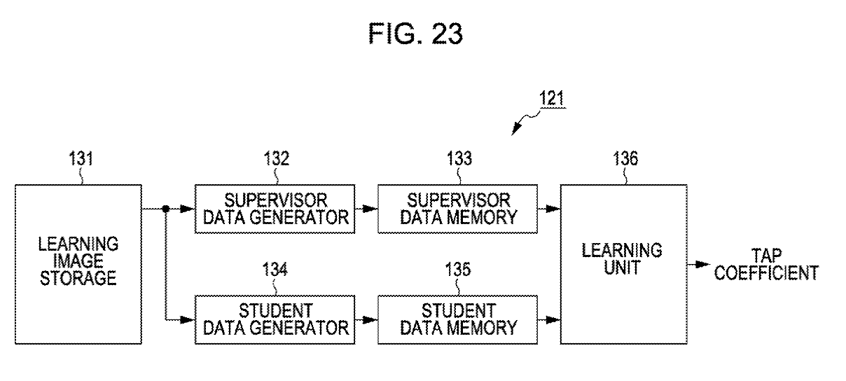

FIG. 23 illustrates a learning apparatus 121 that determines the tap coefficient wₙ by writing and solving the normal equation (8).

As shown in FIG. 23, a learning image storage 131 in the learning apparatus 121 stores learning image data for use in learning the tap coefficient wₙ. The learning image data may be high definition image data having a high definition.

A supervisor data generator 132 reads the learning image data from the learning image storage 131. The supervisor data generator 132 generates a supervisor (true value) in the learning of the tap coefficient from the learning image data, namely, supervisor data becoming a pixel at a map destination in the prediction calculation expressed by equation (1). The supervisor data generator 132 then supplies the supervisor data to a supervisor data memory 133. The supervisor data generator 132 herein supplies as the supervisor data the high definition image data, namely, the learning image data to the supervisor data memory 133.

The supervisor data memory 133 stores as the supervisor data the high definition image data supplied from the supervisor data generator 132. The supervisor data corresponds to the second image data.

A student data generator 134 reads the learning image data from the learning image storage 131. The student data generator 134 generates from the learning image data a student in the learning of the tap coefficient, namely, student data becoming a pixel value to be converted through mapping in the prediction calculation expressed by equation (1). The student data generator 134 filters the high definition image data as the learning image data, thereby lowering definition level. The student data generator 134 thus generates low definition image data and then supplies as the student data the low definition image data to the student data memory 135.

The student data memory 135 stores the student data supplied from the student data generator 134. The student data corresponds to the first image data.

A learning unit 136 successively selects as a target pixel a pixel forming the high definition image data stored as the student data on the supervisor data memory 133. The learning unit 136 selects as a predictive tap a low definition pixel from among low definition pixels forming the low definition image data as the student data stored on the student data memory 135, the selected low definition pixel having the same tap structure as the one selected by the tap selector 112 of FIG. 21. Using each pixel forming the student data and the predictive tap selected at the time the pixel being selected as the target pixel, the learning unit 136 writes and solves equation (8) for each class. The learning unit 136 thus determines the tap coefficient for each class.

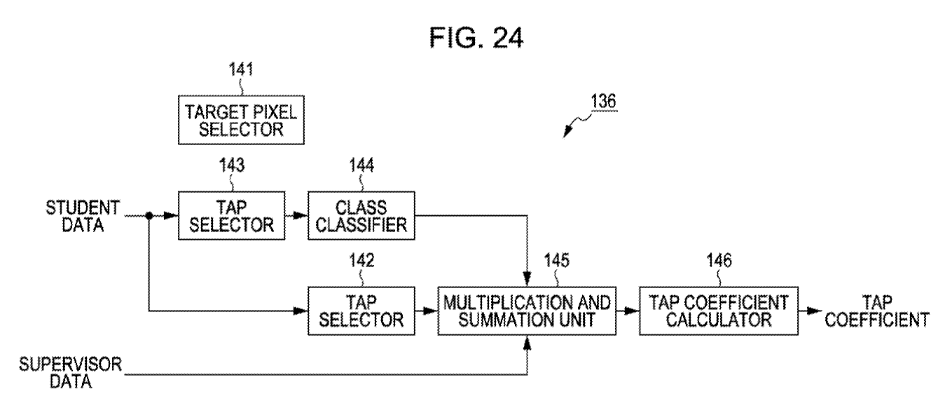

FIG. 24 illustrates the structure of the learning unit 136 of FIG. 23.

A target pixel selector 141 selects as a target pixel each pixel forming the supervisor data stored on the supervisor data memory 133 and supplies information indicating the target pixel to each element.

The tap selector 142 selects the same pixel as the one selected by the tap selector 112 of FIG. 21, from the low definition pixels forming the low definition image data stored as the student data on the student data memory 135. In this way, the tap selector 142 acquires the predictive tap having the same tap structure as that of the one acquired by the tap selector 112 and supplies the predictive tap to a multiplication and summation unit 145.

In response to the target pixel, a tap selector 143 selects the same pixel as the one selected by the tap selector 113 of FIG. 21, from the low definition pixels forming the low definition image data stored as the student data on the student data memory 135. The tap selector 143 thus acquires the class tap having the same tap structure as that of the tap acquired by the tap selector 113. The class tap is then supplied to a class classifier 144.

Based on the class tap output from the tap selector 143, the class classifier 144 performs the same class classification as that of the class classifier 114 of FIG. 21. The class classifier 144 then supplies to the multiplication and summation unit 145 the class code responsive to the class thus obtained.

The multiplication and summation unit 145 reads the supervisor data as the target pixel from the supervisor data memory 133 and performs a multiplication and summation process on the target pixel and the student data forming the predictive tap for the target pixel supplied from the tap selector 142 on a per class code supplied from the class classifier 144.

More specifically, the multiplication and summation unit 145 receives the supervisor data yₖ from the supervisor data memory 133, the predictive tap x_{n,k} output from the tap selector 142 and the class code output from the class classifier 144.

For each class code supplied from the class classifier 144, the multiplication and summation unit 145 performs the multiplication (x_{n,k}x_{n′,k}) of the student data and summation (Σ) in the matrix on the left side of equation (8) using the predictive tap (student data) x_{n,k}.

For each class corresponding to the class code supplied from the class classifier 144, the multiplication and summation unit 145 performs multiplication (x_{n,k}yₖ) and summation (Σ) in the vector on the right side of equation (8) on the student data x_{n,k} and the supervisor data yₖ, using the predictive tap (student data) x_{n,k} and the supervisor data yₖ.

The multiplication and summation unit 145 stores, on an internal memory thereof (not shown), components (Σx_{n,k}x_{n′,k}) of the matrix on the left side and components (Σx_{n,k}yₖ) of the vector on the right side of equation (8) determined for the supervisor data as the previous target pixel. The multiplication and summation unit 145 then sums components x_{n,k+1}x_{n′,k+1} or x_{n,k+1}yₖ₊₁, calculated using the supervisor data yₖ₊₁ as a new target pixel and the student data x_{n,k+1}, to the components (Σx_{n,k}x_{n′,k}) of the matrix and the components (Σx_{n,k}yₖ) of the vector (summation of equation (8)).

The multiplication and summation unit 145 performs the multiplication and summation process with all the supervisor data stored on the supervisor data memory 133 (FIG. 23) as the target pixels. The multiplication and summation unit 145 thus writes the normal equation (8) for each class and then supplies the normal equation (8) to a tap coefficient calculator 146.

The tap coefficient calculator 146 solves the normal equation (8) for each class supplied from the multiplication and summation unit 145, thereby determining and outputting the optimum tap coefficient wₙ for each class.

The coefficient output unit 115 in the image conversion apparatus 101 of FIG. 21 stores the tap coefficient wₙ thus determined for each class.

The tap coefficient permits a variety of image conversion processes to be performed depending on the image data as the student data corresponding to the first image data and the image data as the supervisor data corresponding to the second image data.

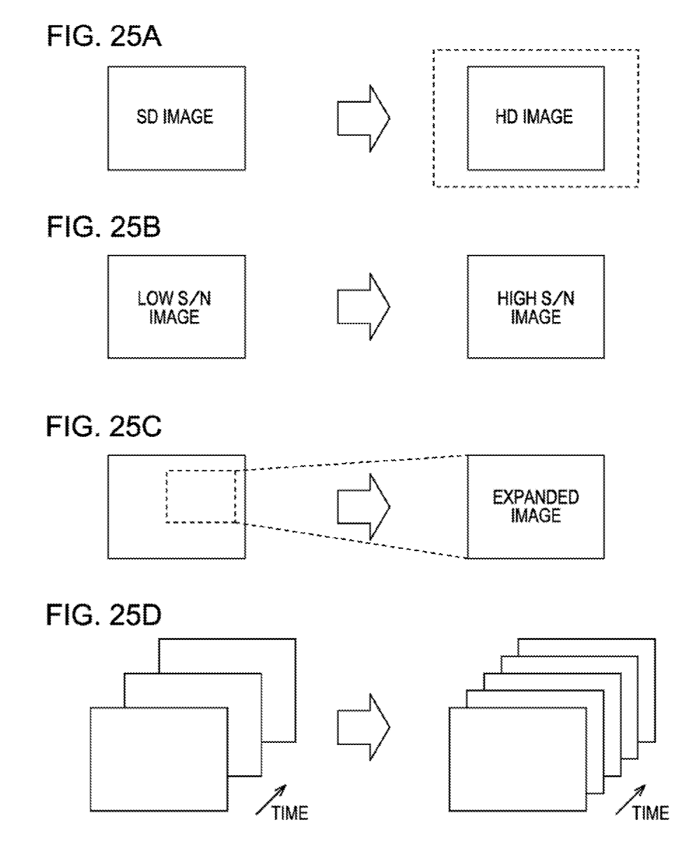

As described above, the high definition image data is the supervisor data corresponding to the second image data and the low definition image data that is obtained by lowering the high definition image data in spatial resolution is the student data corresponding to the first image data. The tap coefficient is learned on the first image data and the second image data. As shown in FIG. 25A, the tap coefficient permits the image conversion process as the spatial resolution improvement process in which the first image data as the low definition image data (standard definition (SD) image data) is converted into the high definition image data (high definition (HD) image data) having a higher spatial resolution.

In this case, the second image data (student data) may or may not have the same pixel count as the second image data (supervisor data).

For example, the high definition image data may be supervisor data and the student data may be image data that is obtained by superimposing noise on the high definition image data as the supervisor data. The tap coefficient is learned on the first image data and the second image data. As shown in FIG. 25B, the tap coefficient permits the image conversion process as a noise removal process in which the first image data as image data having a low S/N ratio is converted into the second image data having a high S/N ratio with noise contained in the first image data removed.

For example, the tap coefficient is learned with given image data being the supervisor data and the student data being image data that results from decimating the pixels of the supervisor data. As shown in FIG. 25C, the tap coefficient permits as the image conversion process a expansion process (resize process) in which the first image data as part of image data is expanded into the second image data.

The tap coefficient for performing the expansion process is learned on the high definition image data as the supervisor data and as the student data the low definition image data that is lowered in spatial resolution by decimating the pixels in the high definition image data.

For example, the tap coefficient is learned on image data having a high frame rate as the supervisor data and, as the student data, image data that results from decimating the frames of the image data having the high frame rate. As shown in FIG. 25D, the tap coefficient permits as the image conversion process a time resolution improvement process in which the first image data having a predetermined frame rate is converted into the second image data having a high frame rate.

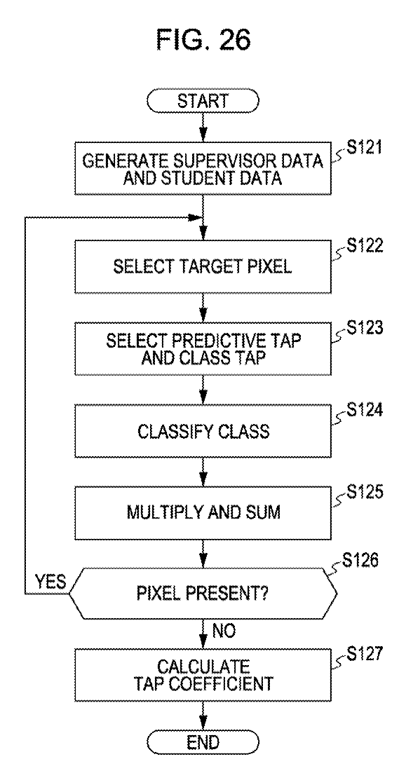

The learning process of the learning apparatus 121 of FIG. 23 is described below with reference to a flowchart of FIG. 26.

In step S121, the supervisor data generator 132 and the student data generator 134 generate the supervisor data and the student data respectively, based on the learning image data stored on the learning image storage 131. The supervisor data and the student data are respectively supplied to the supervisor data memory 133 and the student data memory 135.

The supervisor data generated by the supervisor data generator 132 and the student data generated by the student data generator 134 are different depending on the type of the image conversion process in which the tap coefficient is learned.

In step S122, the target pixel selector 141 in the learning unit 136 (FIG. 24) selects as a target pixel a pixel of the supervisor data not yet selected as a target pixel and stored on the supervisor data memory 133. Processing proceeds to step S123. The tap selector 142 selects, for the target pixel, a pixel of the student data for a predictive tap from the student data stored on the student data memory 135, and then supplies the selected pixel to the multiplication and summation unit 145. The tap selector 143 selects, for the target pixel, the student data, as a class tap, from the student data stored on the student data memory 135, and then supplies the student data to the class classifier 144.

In step S124, the class classifier 144 class classifies the target pixel according to the class tap for the target pixel and outputs the class code responsive to the obtained class to the multiplication and summation unit 145. Processing proceeds to step S125.

In step S125, the multiplication and summation unit 145 reads the target pixel from the supervisor data memory 133, and performs the multiplication and summation process on the target pixel and the student data forming the predictive tap selected for the target pixel supplied from the tap selector 142 in accordance with equation (8) for each class code supplied from the class classifier 144. Processing proceeds to step S126.

In step S126, the target pixel selector 141 determines whether the supervisor data memory 133 still stores the supervisor data not yet selected as a target pixel. If it is determined in step S126 that the supervisor data memory 133 still stores the supervisor data not yet selected as a target pixel, processing returns to step S122. The same process described above is repeated.

If it is determined in step S126 that that the supervisor data memory 133 does not store the supervisor data not yet selected as a target pixel, the multiplication and summation unit 145 supplies to the tap coefficient calculator 146 the matrix on the left side and the vector on the right side of equation (8) obtained for each class through steps S122 through S126. Processing proceeds to step S127.

In step S127, the tap coefficient calculator 146 solves the normal equation composed of the matrix on the left side and the vector on the right side of the normal equation (8) for each class supplied from the multiplication and summation unit 145. The tap coefficient calculator 146 thus determines the tap coefficient wₙ for each class. Processing thus ends.

A class having insufficient number of normal equations for determining the tap coefficient can be caused due to insufficient number of pieces of learning image data. In such a class, the tap coefficient calculator 146 may output a default tap coefficient.

FIG. 27 illustrates the structure of another information converting apparatus 151 performing the image conversion process through class classification adaptive process.

As shown in FIG. 27, elements identical to those illustrated in FIG. 21 are designated with the same reference numerals, and the discussion thereof is omitted as appropriate. The information converting apparatus 151 includes a coefficient output unit 155 instead of the coefficient output unit 115. The rest of the information converting apparatus 151 remains unchanged from the image conversion apparatus 101 of FIG. 21.

The coefficient output unit 155 receives the class (code) from the class classifier 114 and a parameter z input from the outside in response to a user operation or other operation. As will be described later, the coefficient output unit 155 generates the tap coefficient for each class responsive to the parameter z. The coefficient output unit 155 outputs to the prediction calculator 116 tap coefficients of the class from the class classifier 114, from among the tap coefficients of the classes.

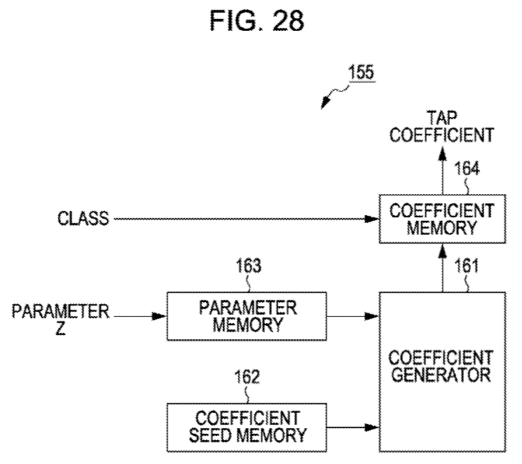

FIG. 28 illustrates the structure of the coefficient output unit 155 of FIG. 27.

A coefficient generator 161 generates the tap coefficient for each class based on coefficient seed data stored on a coefficient seed memory 162 and the parameter z stored on a parameter memory 163 and stores the tap coefficient for each class on a coefficient memory 164 in a overwrite fashion.

The coefficient seed memory 162 stores the coefficient seed data for each class obtained through the learning of the coefficient seed data to be discussed later. The coefficient seed data serves as a seed for generating the tap coefficient.

The parameter memory 163 stores the parameter z input from the outside in response to the user operation or other operation in an overwrite fashion.

A coefficient memory 164 stores the tap coefficient for each class supplied from the coefficient generator 161 (tap coefficient for each class responsive to the parameter z). The coefficient memory 164 reads the tap coefficient of the class supplied from the class classifier 114 (FIG. 27) and then outputs the tap coefficient to the prediction calculator 116 (FIG. 27).

When the coefficient output unit 155 in the information converting apparatus 151 of FIG. 27 receives the parameter z from the outside, the information converting apparatus 151 of FIG. 27 stores the received parameter z on the parameter memory 163 in the coefficient output unit 155 (FIG. 28) in an overwrite fashion.

When the parameter z is stored on the parameter memory 163 (the content of the parameter memory 163 is updated), the coefficient generator 161 reads the coefficient seed data for each class from the coefficient seed memory 162 while also reading the parameter z from the parameter memory 163. The coefficient generator 161 determines the tap coefficient for each class based on the coefficient seed data and the parameter z. The coefficient generator 161 supplies the tap coefficient for each class to the coefficient memory 164 for storage in an overwrite fashion.

The information converting apparatus 151 stores the tap coefficient. The coefficient output unit 155 in the information converting apparatus 151 performs the same process as the one illustrated in the flowchart of FIG. 22 performed by the image conversion apparatus 101 of FIG. 21 except that the tap coefficient responsive to the parameter z is generated and output.

The prediction calculation of the prediction calculator 116 of FIG. 27, the tap coefficient generation of the coefficient generator 161 of FIG. 28 and the learning of the coefficient seed data stored on the coefficient seed memory 162 are described below.

In accordance with the embodiment illustrated in FIG. 21, the second image data is the high definition image data and the first image data is the low definition image data that results from lowering the high definition image data in spatial resolution. The predictive tap is selected from the low definition image data. Using the predictive tap and the tap coefficient, the pixel value of the high definition pixel of the high definition image data is determined (predicted) in accordance with the linear prediction calculation expressed in equation (1).

The pixel value y of the high definition pixel may also be determined using quadratic or higher order equation instead of the linear equation (1).

In accordance with the embodiment illustrated in FIG. 28, the tap coefficient wₙ is generated from the coefficient seed data stored on the coefficient seed memory 162 and the parameter z stored on the parameter memory 163. The coefficient generator 161 herein generates the tap coefficient wₙ in accordance with the following equation (9) using the coefficient seed data and the parameter z.

$${w}_{n} = {\sum }_{m = 1}^{M} {β}_{m , n} {z}^{m - 1} \qquad ( 9 )$$

where β_{m,n} represents m-th coefficient seed data used to determine the n-th tap coefficient wₙ. In equation (9), the tap coefficient wₙ may be determined using M pieces of coefficient seed data β_{1,n}, β_{2,n}, . . . β_{M,n}.

The equation for determining the tap coefficient wₙ from the coefficient seed data β_{m,n} and the parameter z are not limited to equation (9).

A value z^{m-1} determined by the parameter z in equation (9) is defined by introducing a new variable tₘ by the following equation (10):

tₘ=z^{m-1} (m=1, 2, . . . , M) (10)

The following equation (11) is obtained by combining equations (9) and (10):

$${w}_{n} = {\sum }_{m = 1}^{M} {β}_{m , n} {t}_{m} \qquad ( 11 )$$

In accordance with equation (11), the tap coefficient wₙ is determined from an linear equation of the coefficient seed data β_{m,n} and the variable tₘ.

Let yₖ represent the true value of the pixel value of the high definition pixel of the k-th sample and yₖ′ represent the predictive value of the true value yₖ obtained from equation (1), and the predictive error eₖ is expressed by the following equation (12):

eₖ=yₖ−yₖ′ (12)

The predictive value yₖ′ in equation (12) is calculated in accordance with equation (1). If the predictive value yₖ′ in equation (12) is expressed in accordance with equation (1), the following equation (13) results:

$${e}_{k} = {y}_{k} - ( {\sum }_{n = 1}^{N} {w}_{n} {x}_{n , k} ) \qquad ( 13 )$$

where x_{n,k} represents an n-th low definition pixel forming the predictive tap for the high definition pixel of the k-th sample.

By substituting equation (11) for wₙ in equation (13), the following equation (14) results:

$${e}_{k} = {y}_{k} - ( {\sum }_{n = 1}^{N} ( {\sum }_{m = 1}^{M} {β}_{m , n} {t}_{m} ) {x}_{n , k} ) \qquad ( 14 )$$

The coefficient seed data β_{m,n} making the predictive error eₖ in equation (14) zero becomes optimum in the prediction of a high definition pixel. It is generally difficult to determine such coefficient seed data β_{m,n} for all high definition pixels.

The least squares method may be used to determine optimum tap coefficient wₙ. The optimum tap coefficient wₙ may be determined by minimizing the sum E of squared error expressed by the following equation (15):

$$E = {\sum }_{k = 1}^{K} {e}_{k}^{2} \qquad ( 15 )$$

where K represents the number of samples of set composed of the high definition pixel yₖ and low definition pixels x₁ₖ, x₂ₖ, . . . , x_{Nk} forming the predictive tap of the high definition pixel yₖ (namely, the number of learning samples).

As expressed in equation (15), the minimum value of the total sum E of the squared errors of equation (15) is determined by partial differentiating the total sum E by the tap coefficient wₙ and by making the result equal to zero as follows:

$$\frac{\partial E}{\partial {β}_{m , n}} = {\sum }_{k = 1}^{K} 2 \cdot \frac{\partial {e}_{k}}{\partial {β}_{m , n}} \cdot {e}_{k} = 0 \qquad ( 16 )$$

If equation (13) is combined with equation (16), the following equation (17) results:

$${\sum }_{k = 1}^{K} {t}_{m} {x}_{n , k} {e}_{k} = {\sum }_{k = 1}^{K} {t}_{m} {x}_{n , k} ( {y}_{k} - ( {\sum }_{n = 1}^{N} ( {\sum }_{m = 1}^{M} {β}_{m , n} {t}_{m} ) {x}_{n , k} ) = 0 \qquad ( 17 )$$

X_{i,p,j,q} and Y_{i,p} are defined by equations (18) and (19), respectively:

$$\begin{matrix}{X}_{i , p , j , q} = {\sum }_{k = 1}^{K} {x}_{i , k} {t}_{p} {x}_{j , k} {t}_{q} \\ ( \begin{matrix}1 = 1 , 2 , ⋯ , N \text{:} j = 1 , 2 , ⋯ , N \text{:} \\ p = 1 , 2 , ⋯ , M \text{:} q = 1 , 2 , ⋯ , M\end{matrix} ) & ( 18 ) \\ {Y}_{i , p} = {\sum }_{k = 1}^{K} {x}_{i , k} {t}_{p} {y}_{k} & ( 19 )\end{matrix}$$

Equation (17) is expressed by the normal equation (20) using X_{i,p,j,q} and Y_{i,p}:

$$[ \begin{matrix}{X}_{1 , 1 , 1 , 1} & {X}_{1 , 1 , 1 , 2} & ⋯ & {X}_{1 , 1 , 1 , M} & {X}_{1 , 1 , 2 , M} & ⋯ & {X}_{1 , 1 , N , M} \\ {X}_{1 , 2 , 1 , 1} & {X}_{1 , 2 , 1 , 2} & ⋯ & {X}_{1 , 2 , 1 , M} & {X}_{1 , 2 , 1 , M} & ⋯ & {X}_{1 , 2 , N , M} \\ ⋮ & ⋮ & ⋰ & ⋮ & ⋮ & ⋰ & ⋮ \\ {X}_{1 , M , 1 , 1} & {X}_{1 , M , 1 , 2} & ⋯ & {X}_{1 , M , 1 , M} & {X}_{1 , M , 1 , M} & ⋯ & {X}_{1 , M , N , M} \\ {X}_{2 , 1 , 1 , 1} & {X}_{2 , 1 , 1 , 2} & ⋯ & {X}_{2 , M , 1 , M} & {X}_{2 , M , 1 , M} & ⋯ & {X}_{2 , M , N , M} \\ ⋮ & ⋮ & ⋰ & ⋮ & ⋮ & ⋰ & ⋮ \\ {X}_{N , M , 1 , 1} & {X}_{N , M , 1 , 2} & ⋯ & {X}_{N , M , 1 , M} & {X}_{N , M , 1 , M} & ⋯ & {X}_{N , M , N , M}\end{matrix} ] [ \begin{matrix}{β}_{1 , 1} \\ {β}_{2 , 1} \\ ⋮ \\ {β}_{M , 1} \\ {β}_{1 , 2} \\ ⋮ \\ {β}_{M , N}\end{matrix} ] = [ \begin{matrix}{Y}_{1 , 1} \\ {Y}_{1 , 2} \\ ⋮ \\ {Y}_{1 , M} \\ {Y}_{2 , 1} \\ ⋮ \\ {Y}_{N , M}\end{matrix} ] \qquad ( 20 )$$

The normal equation (20) may be solved for the coefficient seed data β_{m,n} using sweep method (Gauss-Jordan elimination).

The information converting apparatus 151 of FIG. 27 uses as the supervisor data a large number of high definition pixels y₁, y₂, . . . , y_{K} serving as a supervisor and, as the student data, low definition pixels x₁ₖ, x₂ₖ, . . . , x_{Nk} forming the predictive tap for each high definition pixel yₖ serving as a student. The information converting apparatus 151 writes and solves the normal equation (20) for each class for the coefficient seed data β_{m,n}. The coefficient seed memory 162 in the coefficient output unit 155 (FIG. 28) stores the coefficient seed data β_{m,n}. In accordance with equation (9), the coefficient generator 161 generates the tap coefficient for each class based on the coefficient seed data β_{m,n} and the parameter z stored on the parameter memory 163. The prediction calculator 116 calculates equation (1) using the tap coefficient wₙ and the low definition pixel xₙ forming the predictive tap for the target pixel as the high definition pixel (pixel of the first image data). The prediction calculator 116 thus determines (the predictive value close to) the pixel value as a high definition pixel.

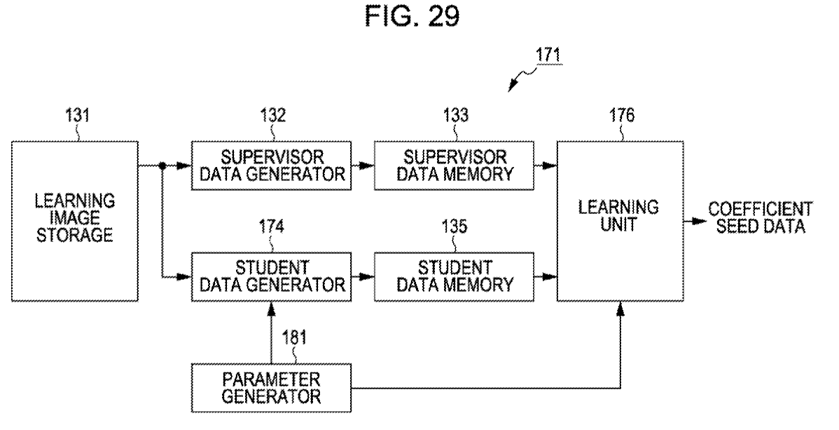

FIG. 29 illustrates a learning apparatus 171 that performs a learning process for determining the coefficient seed data β_{m,n} for each class by writing and solving the normal equation (20) for each class.

As shown in FIG. 29, elements identical to those in the learning apparatus 121 of FIG. 23 are designated with the same reference numerals, and the discussion thereof is omitted as appropriate. More specifically, the learning apparatus 171 includes a parameter generator 181 and a student data generator 174 (instead of the student data generator 134) and a learning unit 176 (instead of the learning unit 136).

As the student data generator 134 of FIG. 23, the student data generator 174 generates the supervisor data from the learning image data and supplies the supervisor data to the student data memory 135.

The student data generator 174 receives the learning image data. The student data generator 174 further receives, from the parameter generator 181, several values falling within a range the parameter z supplied from the parameter memory 163 of FIG. 28 can take. If the range the parameter z can take is real number, the student data generator 174 receives z=0, 1, 2, . . . , Z from the parameter generator 181.

The student data generator 174 generates the low definition image data as the student data by filtering the high definition image data as the learning image data through a low-pass filter (LPF) having a cutoff frequency corresponding to the supplied parameter z.

The student data generator 174 generates the low definition image data as the student data of (Z+1) types different in spatial resolutions in response to the high definition image data as the learning image data.

The larger the value of the parameter z, the higher the cutoff frequency of the LPF becomes. Using such an LPF, the high definition image data is filtered to generate the low definition image data as the student data. Therefore, the larger the value of the parameter z, the higher the low definition image data becomes in spatial resolution.

In accordance with the present embodiment, the student data generator 174 generates the low definition image data that is obtained by lowering the high definition image data in spatial resolution both in a horizontal direction and a vertical direction by an amount corresponding to the parameter z.

The learning unit 176 determines the coefficient seed data for each class using the supervisor data stored on the supervisor data memory 133, the student data stored on the student data memory 135, and the parameter z supplied from the parameter generator 181.

The parameter generator 181 generates several values falling within the range of the parameter z, for example, z=0, 1, 2, . . . , Z and then supplies the values to each of the student data generator 174 and the learning unit 176.

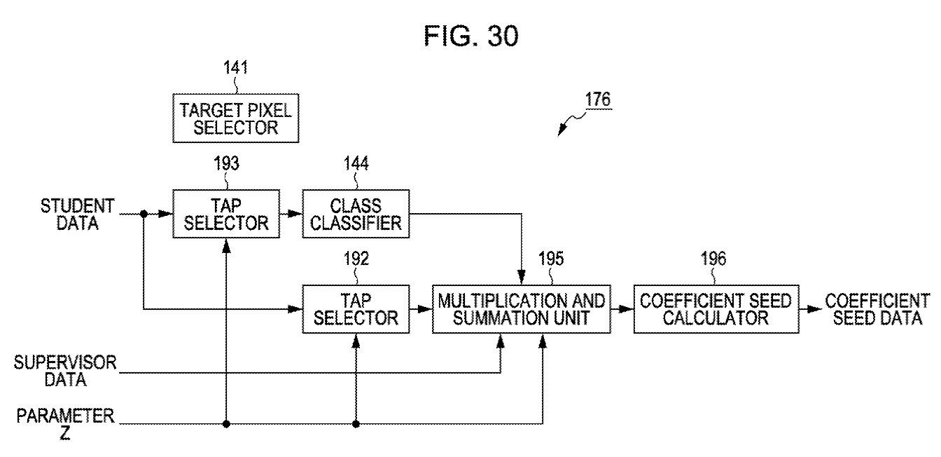

FIG. 30 illustrates the structure of the learning unit 176 of FIG. 29. As shown in FIG. 30, elements identical to those in the learning unit 136 of FIG. 24 are designated with the same reference numerals, and the discussion thereof is omitted as appropriate.

In connection with the target pixel, a tap selector 192 selects the predictive tap having the same tap structure as the one selected by the tap selector 112 of FIG. 27 from the low definition pixels forming the low definition image data as the student data stored on the student data memory 135, and supplies the selected predictive tap to the multiplication and summation unit 195.

In connection with the target pixel, a tap selector 193 selects the class tap having the same tap structure as the one selected by the tap selector 113 of FIG. 27 from the low definition pixels forming the low definition image data as the student data stored on the student data memory 135 and supplies the selected class tap to the class classifier 144.

As shown in FIG. 30, the parameter z generated by the parameter generator 181 of FIG. 29 is supplied to each of the tap selector 192 and the tap selector 193. The tap selector 192 and the tap selector 193 select the predictive tap and the class tap respectively from the student data generated in response to the parameter z supplied from the parameter generator 181 (the low definition image data as the student data generated using the LPF having the cutoff frequency corresponding to the parameter z).

The multiplication and summation unit 195 reads the target pixel from the supervisor data memory 133 of FIG. 29. The multiplication and summation unit 195 performs the multiplication and summation process on the read target pixel, the student data forming the predictive tap for the target pixel supplied from the tap selector 192, and the parameter z at the generation of the student data, for each class supplied from the class classifier 144.

The multiplication and summation unit 195 receives the supervisor data yₖ stored as the target pixel on the supervisor data memory 133, predictive tap x_{i,k} (x_{j,k}) for the target pixel output from the tap selector 192, the class of the target pixel output from the class classifier 144, and the parameter z from the parameter generator 181 at the generation of the student data forming the predictive tap for the target pixel.

Using the predictive tap (student data) x_{i,k} (x_{j,k}) and the parameter z for each class supplied from the class classifier 144, the multiplication and summation unit 195 performs multiplication (x_{i,k}tₚx_{j,k}t_{q}) and summation (Σ) in the matrix on the left side of equation (20) on the student data and the parameter z for determining component X_{i,p,j,q} defined by equation (18). Here, tₚ in equation (18) is calculated from the parameter z in accordance with equation (10). The same is true of t_{q} in equation (18).

Using the predictive tap (student data) x_{i,k}, the supervisor data yₖ and the parameter z for each class supplied from the class classifier 144, the multiplication and summation unit 195 performs multiplication (x_{i,k}tₚyₖ) and summation (Σ) in the vector on the right side of equation (20) on the student data x_{i,k}, the supervisor data yₖ and the parameter z for determining component Y_{i,p} defined by equation (19). Here, tₚ in equation (19) is calculated from the parameter z in accordance with equation (10).

The multiplication and summation unit 195 stores, on an internal memory (not shown), the component X_{i,p,j,q} in the matrix on the left side and the component Y_{i,p} in the vector on the right side of equation (20) determined for the supervisor data as the target pixel. To the component X_{i,p,j,q} in the matrix and the component Y_{i,p} in the vector, the multiplication and summation unit 195 sums the component x_{i,k}tₚx_{j,k}t_{q} or x_{i,k}tₚyₖ calculated using the supervisor data yₖ, the student data x_{i,k}(x_{j,k}) and the parameter z relating to supervisor data as a new target pixel (summation performed in the component X_{i,p,j,q} of equation (18) or component Y_{i,p} of equation (19)).

The multiplication and summation unit 195 performs the multiplication and summation process on all the supervisor data stored as the target pixel on the supervisor data memory 133 for all the values of the parameter z including 0, 1, . . . , Z. The multiplication and summation unit 195 thus writes the normal equation (20) for each class and then supplies the normal equation (20) to the coefficient seed generator 196.

The coefficient seed calculator 196 determines the coefficient seed data β_{m,n} for each class by solving the normal equation of each class supplied from the multiplication and summation unit 195.

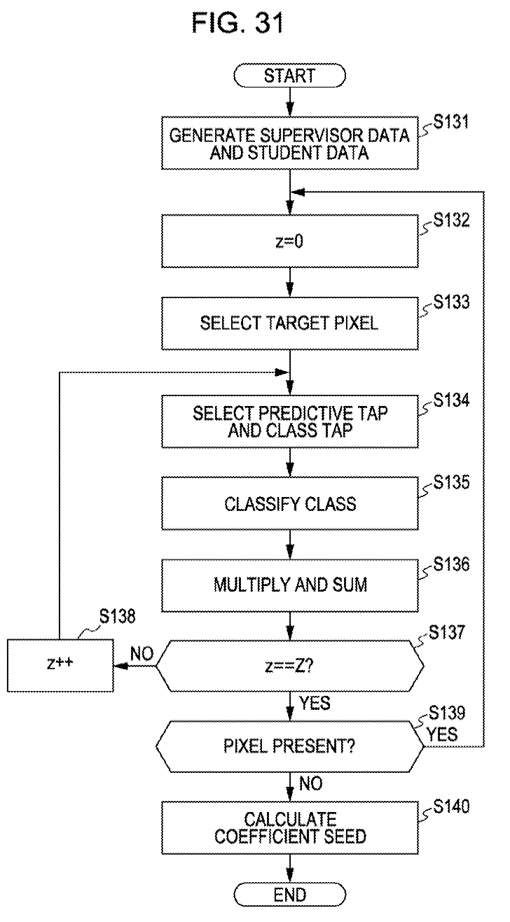

The learning process of the learning apparatus 171 of FIG. 29 is described below with reference to a flowchart of FIG. 31.

In step S131, the supervisor data generator 132 and the student data generator 174 respectively generate the supervisor data and the student data from the learning image data stored on the learning image storage 131 and output respectively generated data. More specifically, the supervisor data generator 132 directly outputs the learning image data as the supervisor data. The student data generator 174 receives the parameter z having (Z+1) values generated by the parameter generator 181. The student data generator 174 filters the learning image data using the LPF having a cutoff frequency corresponding to the parameter z having (Z+1) values (0, 1, . . . , Z) from the parameter generator 181, thereby generating and outputting the student data of the (Z+1) frames regarding the supervisor data (learning image data) of each frame.

The supervisor data output by the supervisor data generator 132 is supplied to the supervisor data memory 133 for storage, and the student data output by the student data generator 174 is supplied to the student data memory 135 for storage.

In step S132, the parameter generator 181 sets the parameter z to an initial value such as zero, and then supplies the parameter z to each of the tap selector 192, the tap selector 193 and the multiplication and summation unit 195 in the learning unit 176 (FIG. 30). Processing proceeds to step S133. In step S133, the target pixel selector 141 sets, as a target pixel, one of the pixels not yet selected as a target pixel, in the supervisor data stored on the supervisor data memory 133. Processing proceeds to step S134.

In step S134, the tap selector 192 selects a predictive tap from the student data corresponding to the parameter z stored on the student data memory 135 and output from the parameter generator 181 (the student data being generated by filtering the learning image data corresponding to the supervisor data selected as the target pixel using the LPF having the cutoff frequency corresponding to the parameter z) and then supplies the selected predictive tap to the multiplication and summation unit 195. Also in step S134, the tap selector 193 selects the class tap from the student data corresponding to the parameter z, stored by the student data memory 135 and output by the parameter generator 181 with reference to the target pixel and supplies the selected class tap to the class classifier 144.

In step S135, the class classifier 144 class classifies the target pixel based on the class tap with reference to the target pixel and outputs the class of the resulting target pixel to the multiplication and summation unit 195. Processing proceeds to step S136.

In step S135, the multiplication and summation unit 195 reads the target pixel from the supervisor data memory 133. The multiplication and summation unit 195 calculates the component x_{i,K}tₚx_{j,K}t_{q} in the matrix on the left side of equation (20) and the component x_{i,K}tₚy_{K} of the vector on the right side of equation (20) using the target pixel, the predictive tap supplied from the tap selector 192 and the parameter z output from the parameter generator 181. Furthermore, the multiplication and summation unit 195 sums the component x_{i,K}tₚx_{j,K}t_{q} of the matrix and the component x_{i,K}tₚy_{K} of the vector, determined from the target pixel, the predictive tap and the parameter z, to components of the class of the target pixel from the class classifier 144, from among the already obtained components of the matrix and the already obtained components of the vector. Processing proceeds to step S137.

In step S137, the parameter generator 181 determines whether the parameter z output by the parameter generator 181 itself equals Z that is a maximum value the parameter z can take. If it is determined in step S137 that the parameter z output by the parameter generator 181 is not equal to (less than) a maximum value Z, processing proceeds to step S138. The parameter generator 181 adds 1 to the parameter z, sets the resulting sum as a new parameter z, and outputs the new parameter z to each of the tap selector 192, the tap selector 193 and the multiplication and summation unit 195 in the learning unit 176 (FIG. 30). Processing returns to step S134 to repeat step S134 and subsequent steps.

If it is determined in step S137 that the parameter z is the maximum value Z, processing proceeds to step S139. The target pixel selector 141 determines whether the supervisor data memory 133 stores the supervisor data not yet selected as a target pixel. If it is determined in step S139 that the supervisor data not yet selected as the target pixel is still stored on the supervisor data memory 133, processing returns to step S132 to repeat step S132 and subsequent steps.

If it is determined in step S139 that the supervisor data not yet selected as the target pixel is not stored on the supervisor data memory 133, the multiplication and summation unit 195 supplies to the coefficient seed calculator 196 the matrix on the left side and the vector on the right side of equation (20) obtained heretofore for each class and proceeds to step S140.

In step S140, the coefficient seed calculator 196 solves the normal equation for each class composed of the matrix on the left side and the vector on the right side of equation (20) supplied from the multiplication and summation unit 195, thereby generating and outputting the coefficient seed data β_{m,n} for each class. Processing thus ends.

The number of normal equations required to determine the coefficient seed data may be insufficient in some classes due to insufficient number of pieces of learning image data. In such a class, the coefficient seed calculator 196 outputs default coefficient seed data.

The size conversion of the image converter 24 (FIGS. 5 and 13) is performed through the above-described class classification adaptive process.

The image converter 24 performs the size conversion by performing the class classification adaptive process. The learning apparatus 171 of FIG. 29 learns the coefficient seed data on supervisor data and student data. Given image data may serve as the supervisor data and image data that is obtained by decimating the supervisor data in pixel count in accordance with the parameter z may serve as student data. Alternatively, image data having a predetermined size may serve student data and image data that is obtained by decimating the student data in pixel count at a decimation ratio corresponding to the parameter z may serve supervisor data.

The image converter 24, including the information converting apparatus 151 of FIG. 27, stores the coefficient seed data determined through the learning process on the coefficient seed memory 162 (FIG. 28). The coefficient seed memory 162 forms the coefficient output unit 155 in the information converting apparatus 151 (FIG. 27) as the image converter 24.

The image format detector 22 (FIGS. 5 and 13) supplies the information converting apparatus 151 as the image converter 24 with a conversion coefficient, as the parameter z, for equalizing one of the horizontal pixel count and the vertical pixel count of the effective image to one of the horizontal pixel count and the vertical pixel count of the display screen of the display 26. In this way, by performing the class classification adaptive process, the information converting apparatus 151 as the image converter 24 performs the size conversion to equalize one of the horizontal pixel count and the vertical pixel count of the effective image to one of the horizontal pixel count and the vertical pixel count of the display screen of the display 26.

The above-referenced series of process steps may be performed using hardware or software. If the process steps are performed using software, a program of the software may be installed onto a general-purpose personal computer.

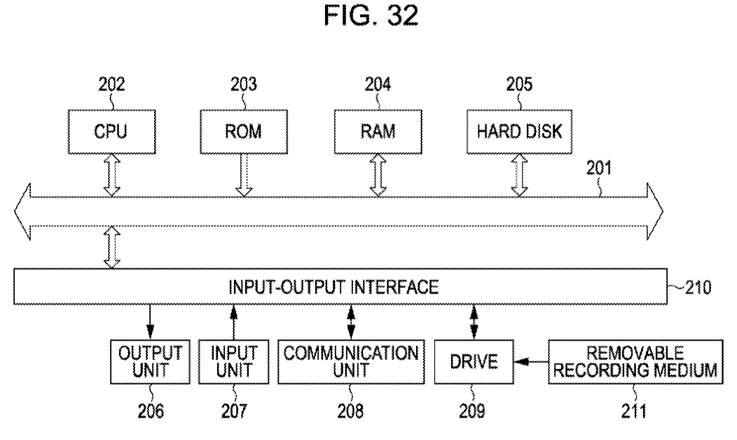

FIG. 32 is a block diagram illustrating the personal computer executing the above series of process steps in accordance with one embodiment of the present invention.

The program may be pre-stored on one of a hard disk 205 and a read-only memory (ROM) 203 as a recording medium in the computer.

The program may also be stored temporarily or permanently on a removable recording medium 211 such as a flexible disk, a compact disk read only memory (CD-ROM), a magneto-optical (MO) disk, a digital versatile disk (DVD), a magnetic disk or a semiconductor memory. The removable recording medium 211 may be supplied as so-called package software.

The program may be installed from the above-mentioned removable recording medium 211. Alternatively, the program may be transferred to the computer from a download site via a digital broadcasting satellite in a wireless fashion or via a network such as a local area network (LAN) or the Internet in a wired fashion. The computer receives the transferred program using a communication unit 208 and installs the received program on the hard disk 205.

The computer includes a central processing unit (CPU) 202. Upon receiving an instruction in response to an operation performed by a user to the input unit 207 composed of a keyboard, a mouse, a microphone, and the like, the CPU 202 executes a program stored on the read-only memory (ROM) 203. Alternatively, the CPU 202 loads to a random-access memory (RAM) 204 one of the program stored on the hard disk 205, the program transferred via the satellite or the network, received by the communication unit 208 and installed on the hard disk 205, and the program read from the removable recording medium 211 on a drive 209 and installed on the hard disk 205, and then the CPU 202 executes the program loaded on the RAM 204. The CPU 202 thus performs the process in accordance with the above-described flowcharts or the process described with reference to the above-described block diagrams. As appropriate, the CPU 202 outputs the process results from an output unit 206 composed of a liquid-crystal display (LCD), a loudspeaker, and the like via the input-output interface 210, transmits the process results from the communication unit 208, or stores the process results onto the hard disk 205.

The process steps described in this specification is performed in the time-series order sequence as previously stated. Alternatively, the process steps may be performed in parallel or separately.

The program may be performed by a single computer or a plurality of computers in a distributed fashion. Alternatively, the program may be transferred to a remote computer to be performed.

It should be understood by those skilled in the art that various modifications, combinations, sub-combinations and alterations may occur depending on design requirements and other factors insofar as they are within the scope of the appended claims or the equivalents thereof.

In accordance with the embodiments of the present invention, the ticker process has been discussed with the 4:3 display image displayed on the 16:9 screen. The ticker process described previously is also applicable when the 16:9 image is displayed on the 4:3 screen.

The effective image, the display image and the aspect ratio of the display screen of the display 26 are not limited to 4:3 and 16:9.

In the previously described embodiments, the image converter 24 (FIGS. 5 and 13) performs the size conversion on the entire effective image for simplicity of explanation. The size conversion may be performed on only a portion of the display area of the display image of the effective image subsequent to the size conversion.

In accordance with the embodiments, the buffer 21 in the display processing apparatus 20 (FIGS. 5 and 13) receives data broadcast by the terrestrial digital broadcasting system. Furthermore, the buffer 21 may receive data reproduced from a recording medium such as a DVD or the like.

What is claimed is:

1. An image processing apparatus for causing display means to display an image, comprising:
image format detecting means for detecting an image format of the image containing an aspect ratio of the image;
converting means for converting an effective image as an effective moving image portion of the image into a display image in accordance with the image format and a screen format of a display screen of the display means, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image; and
scroll processing means for scrolling the display image displayed on the display means in a direction that causes a non-display area as a portion of the display image not appearing on the display screen to appear.

2. The image processing apparatus according to claim 1, wherein the converting means comprises:
predictive tap selecting means for selecting from the effective image a pixel serving as a predictive tap for use in prediction calculation to determine a pixel value of a target pixel in the display image;
class classifying means for classifying the target pixel into one of a plurality of classes according to a predetermined rule;
tap coefficient output means for outputting a tap coefficient of the class of the target pixel from among tap coefficients, the tap coefficients being determined in a learning operation that minimizes an error between the result of the prediction calculation based on the effective image as a student image and the display image as a supervisor image, and being used in the prediction calculation in each of the plurality of classes; and
calculating means for calculating the pixel value of the target pixel by performing the prediction calculation using the tap coefficient of the class of the target pixel and the predictive tap of the target pixel.

3. The image processing apparatus according to claim 1, further comprising:
ticker determining means for determining whether a ticker area containing a ticker is present in the non-display area of the display image; and
ticker area blending means for blending the ticker area of the non-display area with a blend area as part of the display area of the display image displayed on the display screen according to a predetermined blending ratio.

4. The image processing apparatus according to claim 3, wherein the ticker area blending means blends the ticker area with the blend area according to the blending ratio responsive to a user operation.

5. The image processing apparatus according to claim 3, wherein the ticker area blending means blends the ticker area with the blend area according to the blending ratio responsive to a distance between the ticker area and the blend area.

6. The image processing apparatus according to claim 3, wherein the ticker determining means determines whether a ticker area is present in the blend area, and
wherein the scroll processing means scrolls the display image displayed on the display means so that the ticker area is entirely displayed on the display area if the ticker area is present in the blend area.

7. The image processing apparatus according to claim 3, wherein the ticker determining means determines whether a ticker area is present in the blend area, and
wherein the scroll processing means scrolls the display image displayed on the display means so that the ticker area is entirely contained in the non-display area if the ticker area is present in the blend area.

8. An image processing method for causing a display to display an image, comprising steps of:
detecting an image format of the image containing an aspect ratio of the image;
converting an effective image as an effective moving image portion of the image into a display image in accordance with the image format and a screen format of a display screen of the display, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image; and
scrolling the display image displayed on the display in a direction that causes a non-display area as a portion of the display image not appearing on the display screen to appear.

9. A computer program for causing a computer to cause a display to display an image, comprising steps of:
detecting an image format of the image containing an aspect ratio of the image;
converting an effective image as an effective moving image portion of the image into a display image in accordance with the image format and a screen format of a display screen of the display, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image; and
scrolling the display image displayed on the display in a direction that causes a non-display area as a portion of the display image not appearing on the display screen to appear.

10. An image processing apparatus for causing a display unit to display an image, comprising:
an image format detecting unit detecting an image format of the image containing an aspect ratio of the image;
a converting unit converting an effective image as an effective moving image portion of the image into a display image in accordance with the image format and a screen format of a display screen of the display unit, the display image having one of a horizontal size and a vertical size thereof equal to one of a horizontal size and a vertical size of the display screen, and having an image size thereof, being equal to or greater than the size of the display screen and resulting from magnifying the effective image with the same magnification applied to the horizontal size and the vertical size of the effective image; and
a scroll processing unit scrolling the display image displayed on the display unit in a direction that causes a non-display area as a portion of the display image not appearing on the display screen to appear.
